(19) United States
(12) Patent Application Publication
(10) Pub. No.: US 2026/0079243 A1
(43) Pub. Date: Mar. 19, 2026

(54) LIGHT-EMITTING UNIT THAT CAN CONTROL RADIATION ANGLE IN VARIOUS WAYS AND TOF SENSOR INCLUDING THE SAME

(71) Applicant: OPTICIS CO., LTD., Seongnam-si (KR)

(72) Inventors: Hee Dae KIM, Gwangju (KR); Su Hyun LIM, Gwangju (KR)

(73) Assignee: OPTICIS CO., LTD., Seongnam-si (KR)

(21) Appl. No.: 19/025,470

(22) Filed: Jan. 16, 2025

(30) Foreign Application Priority Data
Sep. 13, 2024 (KR) 10-2024-0125401

(51) Int. Cl. G01S 7/481; G01S 17/93; G02B 3/00

(52) U.S. Cl. CPC G01S 7/4815; G01S 17/93; G02B 3/0043; G02B 2003/0093

(57) ABSTRACT

Disclosed are a light-emitting unit that can control a radiation angle in various ways and a TOF sensor including the same. A light-emitting unit includes a base substrate, a plurality of groups of light-emitting elements arranged on the base substrate and sequentially arranged in a preset shape at the outermost position and inside the outermost position, and address lines electrically connected to the light-emitting elements of each group, respectively, and electrically disconnected from each other. Some or all of the light-emitting elements have different radiation angles.

### CROSS-REFERENCE TO RELATED APPLICATION

The present application claims priority under 35 U.S.C. § 119(a) to Korean Patent Application No. 10-2024-0125401 filed in the Korean Intellectual Property Office on Sep. 13, 2024, the entire disclosure of which is incorporated herein by reference.

### BACKGROUND

### 1. Technical Field

The present disclosure relates to a light-emitting unit that can control a radiation angle in various ways and a TOF sensor including the same.

### 2. Related Art

Contents described in this part merely provide background information of the present embodiment, and do not constitute a conventional technology.

Transport robots that transport cargo such as various sizes of freight or products are appearing in logistics warehouses, production lines, or the like. The transport robots may be driven in an autonomous driving mode that recognizes a current position, generates an optimized path to a target position, and follows the path according to an autonomous driving algorithm. The transport robot may include a time of flight (TOF) sensor for recognizing the surrounding environment around the transport robot.

The TOF sensor may detect a transmission time of light emitted from a plurality of light-emitting elements and a reception time of reflected light reflected from a surrounding object and sensed by a plurality of light-receiving elements, and sense a distance and a position to the surrounding object according to a light flight distance. The TOF sensor may include, for example, a light imaging detection and ranging (LIDAR) sensor.

In the TOF sensor in the related art, adjustment of a radiation angle is significantly limited when outting light. It is efficient to output light at different radiation angles when outputting light to a far distance and outputting light to a short distance, but the TOF sensor in the related art does not adjust a radiation angle in various ways.

### SUMMARY

Embodiments of the present disclosure are directed to providing a light-emitting unit that can switch ON/OFF one group of light-emitting elements different from each other at different times through address lines electrically disconnected from each other, and includes one group of optical lenses different from each other and disposed on one group of light-emitting elements different from each other in order to shape different types of lights capable of providing different spot sizes and viewing distances, and a TOF sensor including the same.

Embodiments of the present disclosure are directed to providing a light-emitting unit that can alleviate a heat generation problem occurring when one group of light-emitting elements different from each other are turned on at different times and adjacent light-emitting elements are simultaneously turned on, and a TOF sensor including the same.

Embodiments of the present disclosure are directed to providing a light-emitting unit that disposes a plurality of light-emitting elements on one base substrate and includes a plurality of light-emitting elements provided with an ion implantation layer so as to maintain an appropriate amount of light from each light-emitting element, to block defect migration from a defect source such as an oxide layer or an etched portion in order to prevent deterioration of the light-emitting element, and to block defect migration from the defect source to a central region of an active layer in which carrier confinement and optical confinement are performed, in consideration of the number of light-emitting elements instantaneously turned on, and a TOF sensor including the same.

Embodiments of the present disclosure are directed to providing a light-emitting unit that can control a radiation angle in various ways and a TOF sensor including the same.

According to an aspect of the present disclosure, a light-emitting unit may include: a base substrate; a plurality of groups of light-emitting elements arranged on the base substrate and sequentially arranged in a preset shape at the outermost position and inside the outermost position; and address lines electrically connected to the light-emitting elements of each group, respectively, and electrically disconnected from each other, wherein some or all of the light-emitting elements have different radiation angles.

According to an aspect of the present disclosure, the light-emitting unit further includes a plurality of groups of optical lenses disposed on the light-emitting elements of each group.

According to an aspect of the present disclosure, some of the optical lenses are not disposed on the light-emitting elements.

According to an aspect of the present disclosure, some or all of the optical lenses have different curvatures or refractive powers.

According to an aspect of the present disclosure, some or all of the light-emitting elements have different spot sizes.

According to an aspect of the present disclosure, a light-emitting element that needs to emit light to a far distance emits light to have a relatively narrow radiation angle.

According to an aspect of the present disclosure, a light-emitting element that needs to emit light to a near distance emits light to have a relatively wide radiation angle.

According to an aspect of the present disclosure, the TOF sensor may include: a light-emitting array including a light-emitting unit; a light-receiving unit configured to receive reflected light reflected from an object; and an operation processing unit configured to calculate, from a transmission time of light from the light-emitting unit and a reception time of reflected light sensed by the light-receiving unit, a light flight time corresponding to a time difference between the transmission time of the light and the reception time of the light, and to calculate a distance to the object from the calculated light flight time, wherein the light-emitting unit includes: a base substrate; a plurality of groups of light-emitting elements arranged on the base substrate and sequentially arranged in a preset shape at the outermost position and inside the outermost position; and address lines electrically connected to the light-emitting elements of each group, respectively, and electrically disconnected from each other, wherein some or all of the light-emitting elements have different radiation angles.

According to an aspect of the present disclosure, the TOF sensor further includes a plurality of groups of optical lenses disposed on the light-emitting elements of each group.

According to an aspect of the present disclosure, some or all of the optical lenses have different curvatures or refractive powers.

As described above, an aspect of the present disclosure has advantages in that it can switch ON/OFF one group of light-emitting elements different from each other at different times through address lines electrically disconnected from each other and provide different spot sizes and viewing distances.

An aspect of the present disclosure has advantages in that it can alleviate a heat generation problem occurring when one group of light-emitting elements different from each other are turned on at different times and adjacent light-emitting elements are simultaneously turned on.

An aspect of the present disclosure has advantages in that it disposes a plurality of light-emitting elements on one base substrate and can maintain an appropriate amount of light from each light-emitting element, block defect migration from a defect source such as an oxide layer or an etched portion in order to prevent deterioration of the light-emitting element, and block defect migration from the defect source to a central region of an active layer in which carrier confinement and optical confinement are performed, in consideration of the number of light-emitting elements instantaneously turned on.

An aspect of the present disclosure has advantages in that it can control a radiation angle in various ways when outputting light.

### BRIEF DESCRIPTION OF THE DRAWINGS

FIG. 1 is a view for explaining a light-emitting element array EA in which a plurality of light-emitting elements are arranged two-dimensionally according to an embodiment of the present disclosure.

FIG. 2 is a view taken along line II-II in FIG. 1 and schematically illustrating an arrangement of a plurality of light-emitting elements E arranged one-dimensionally along one direction.

FIG. 3 is a view three-dimensionally illustrating the light-emitting element E illustrated in FIG. 2.

FIG. 4 is a view illustrating the cross-sectional structure of the light-emitting element E according to an embodiment of the present disclosure.

FIGS. 5 to 7 are views for explaining the light-emitting element E illustrated in FIG. 4, and are views illustrating the cross-sectional structure of the light-emitting element E illustrated in FIG. 4 at different phases in which the light-emitting element E is formed.

FIG. 8 is a view illustrating the cross-sectional structure of a light-emitting element E according to another embodiment of the present disclosure.

FIGS. 9 to 11 are views illustrating the cross-sectional structure of the light-emitting element E illustrated in FIG. 8 at different phases in which the light-emitting element E is formed.

FIG. 12 is a view schematically illustrating the structure of a TOF sensor TOF including a light-emitting unit EU including a plurality of light-emitting elements E and a light-receiving unit DU including a plurality of light-receiving elements.

FIG. 13 is a view illustrating the cross-sectional structure of a light-emitting unit EU including an optical lens array FA arranged on a light-emitting element array EA in an embodiment of the present disclosure.

FIG. 14 is a view exemplarily illustrating the forms of lights emitted from the light-emitting unit EU illustrated in FIG. 13 and providing different spot sizes (different radiation angles) and visual fields.

FIG. 15 is a view illustrating a form in which lights providing different spot sizes (different radiation angles) and visual fields are sequentially output in a phase in which a light-emitting element assembly ES1 of a first group to a light-emitting element assembly ES4 of a fourth group in the light-emitting unit EU illustrated in FIG. 13 are sequentially driven, for example, at different times T1 to T4.

FIG. 16 is a view illustrating a comparison of the forms of lights emitted from the light-emitting element assemblies ES1 to ES4 of the first to fourth groups in the light-emitting unit EU illustrated in FIG. 13 and providing different spot sizes (different radiation angles) and visual fields.

FIGS. 17A, 17B, and 17C are views for explaining a configuration for sensing a distant object, a configuration for increasing light intensity with the same spot size, and a configuration for reducing the spot size of light.

FIGS. 18A and 18B are views for explaining a configuration for increasing sensitivity with the same light intensity.

FIGS. 19 to 24 are views for explaining address structures of light-emitting units EU having different address structures for independently applying a driving voltage V to each of the light-emitting element assemblies ES1 to ES4 of the first to fourth groups.

FIG. 25 is a view for explaining an embodiment for implementing a switching operation by interposing a switch between a driving power source V and first to fourth contact points CP1 to CP4 connected to address lines A1 to A4 of the first to fourth groups.

FIG. 26 is a view illustrating the cross-sectional structure of a light-emitting unit EU including an optical lens array FA arranged on a light-emitting element array EA in another embodiment of the present disclosure.

FIG. 27 is a view exemplarily illustrating the forms of lights emitted from the light-emitting unit EU illustrated in FIG. 26 and providing different spot sizes (different radiation angles) and visual fields.

FIG. 28 is a view exemplarily illustrating different forms of lights emitted from the light-emitting unit EU illustrated in FIG. 26.

FIG. 29 is a view exemplarily illustrating a form in which lights providing different spot sizes (different radiation angles) and visual fields are sequentially output in a phase in which a light-emitting element assembly ES1 of a first group to a light-emitting element assembly ES4 of a fourth group in the light-emitting unit EU illustrated in FIG. 26 are sequentially driven, for example, at different times T1 to T4.

FIG. 30 is a view illustrating the cross-sectional structure of a light-emitting unit EU including an overlapping arrangement of a first condensing lens L1 supported on a light-emitting element E and a second condensing lens L2 spaced apart from the light-emitting element E in another embodiment of the present disclosure.

FIGS. 31 to 33 are views exemplarily illustrating different forms of lights provided from the light-emitting unit EU according to different first to third positions g1 to g3 of the second condensing lens L2 with respect to the first condensing lens L1 in the light-emitting unit EU illustrated in FIG. 30.

FIGS. 34 to 37 are views illustrating the forms of lights deflected at different degrees from the center of the first condensing lens L1 toward the center of the second condensing lens L2 through different curvatures or refractive powers or different optical arrangements of the first and second condensing lenses L1 and L2 in the light-emitting unit EU illustrated in FIG. 30.

FIGS. 38A to 38C are views for explaining the technical effects of alleviating the deterioration of the light-emitting element E in the light-emitting element array EA or the light-emitting unit EU including the light-emitting element array EA according to an embodiment of the present disclosure.

### DETAILED DESCRIPTION

The present disclosure may be changed in various ways and may have various embodiments. Specific embodiments are to be illustrated in the drawings and specifically described. It should be understood that the present disclosure is not intended to be limited to the specific embodiments, but includes all of changes, equivalents and/or substitutions included in the spirit and technical range of the present disclosure. Similar reference numerals are used for similar components while each drawing is described.

Terms, such as a first, a second, A, and B, may be used to describe various components, but the components should not be restricted by the terms. The terms are used to only distinguish one component from another component. For example, a first component may be referred to as a second component without departing from the scope of rights of the present disclosure. Likewise, a second component may be referred to as a first component. The term “and/or” includes a combination of a plurality of related and described items or any one of a plurality of related and described items.

When it is described that one component is “connected” or “coupled” to the other component, it should be understood that one component may be directly connected or coupled to the other component, but a third component may exist between the two components. In contrast, when it is described that one component is “directly connected to” or “directly coupled to” the other component, it should be understood that a third component does not exist between the two components.

Terms used in this application are used to only describe specific embodiments and are not intended to restrict the present disclosure. An expression of the singular number includes an expression of the plural number unless clearly defined otherwise in the context. In the present specification, a term, such as “include” or “have”, is intended to designate the presence of a characteristic, a number, a step, an operation, a component, a part described in the present specification or a combination of them, and should be understood that it does not exclude the possibility of the existence or addition of one or more other characteristics, numbers, steps, operations, components, parts, or combinations of them in advance.

All terms used herein, including technical or scientific terms, have the same meanings as those commonly understood by a person having ordinary knowledge in the art to which the present disclosure pertains, unless defined otherwise in the specification.

Terms, such as those defined in commonly used dictionaries, should be construed as having the same meanings as those in the context of a related technology, and are not construed as ideal or excessively formal meanings unless explicitly defined otherwise in the application.

Furthermore, each construction, process, procedure, or method included in each embodiment of the present disclosure may be shared within a range in which the constructions, processes, procedures, or methods do not contradict each other technically.

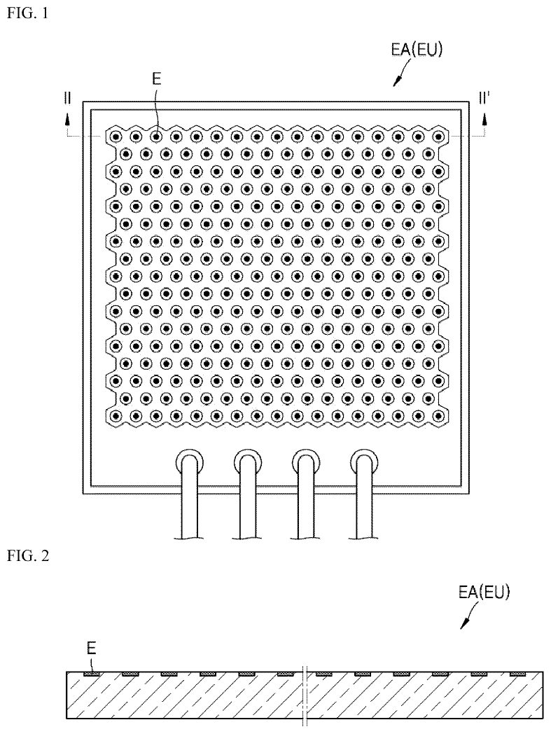

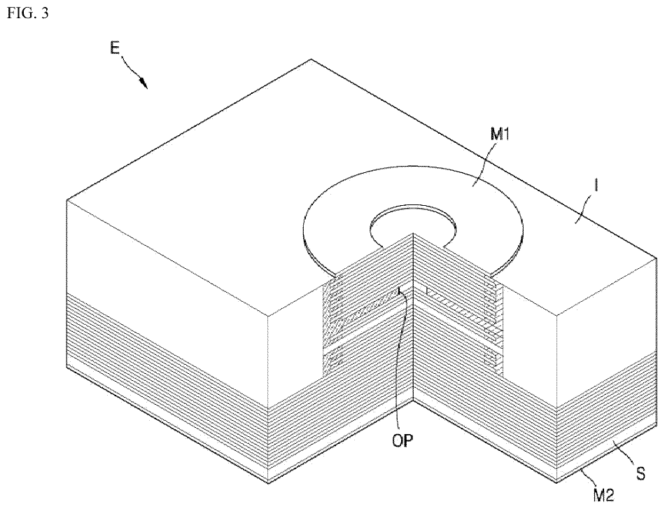

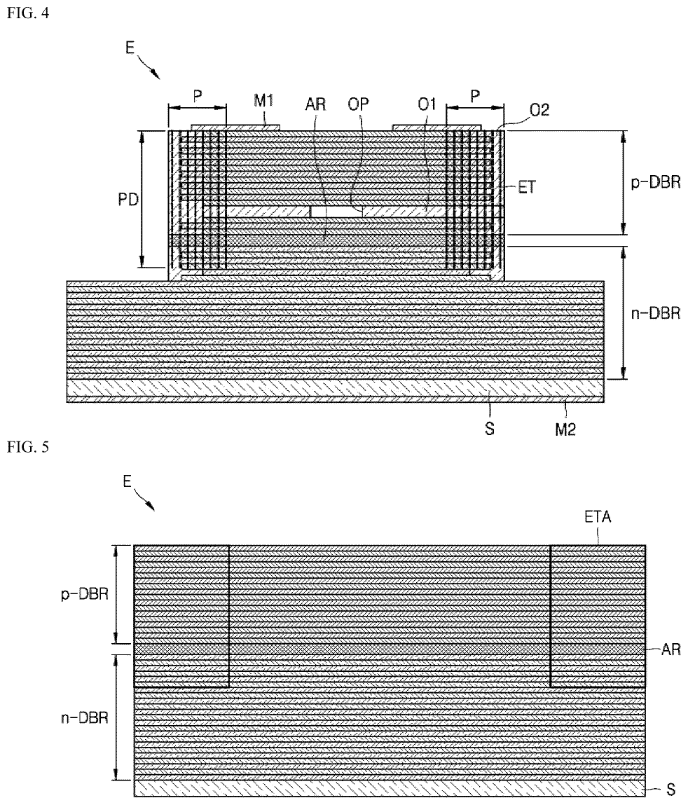

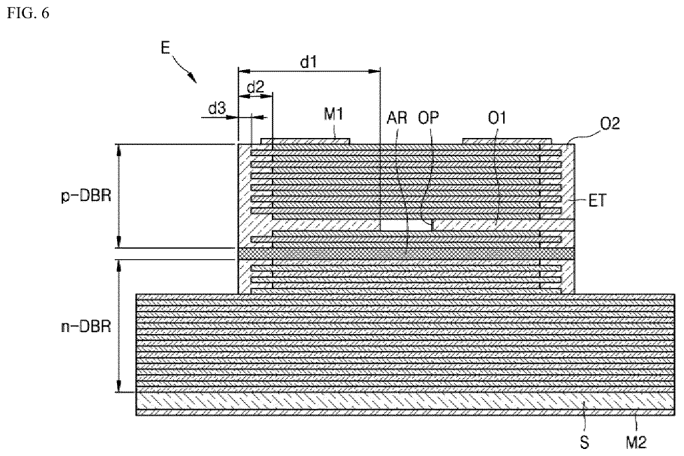

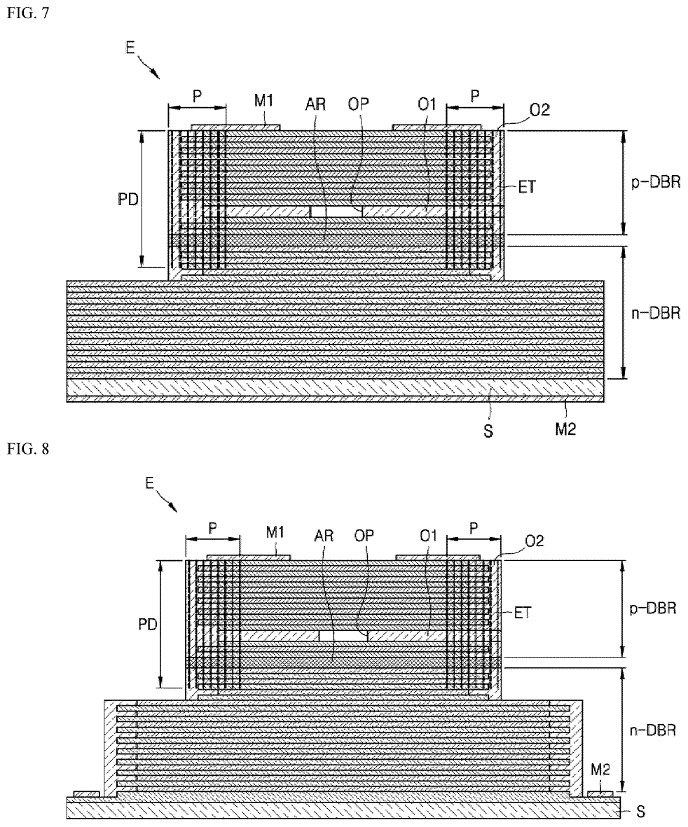

FIG. 1 is a view for explaining a light-emitting element array EA in which a plurality of light-emitting elements E are arranged two-dimensionally according to an embodiment of the present disclosure. FIG. 2 is a view taken along line II-II in FIG. 1 and schematically illustrating an arrangement of a plurality of light-emitting elements E arranged one-dimensionally along one direction. FIG. 3 is a view three-dimensionally illustrating the light-emitting element E illustrated in FIG. 2. FIG. 4 is a view illustrating the cross-sectional structure of the light-emitting element E according to an embodiment of the present disclosure. FIGS. 5 to 7 are views for explaining the light-emitting element E illustrated in FIG. 4 and are views illustrating the cross-sectional structure of the light-emitting element E illustrated in FIG. 4 at different phases in which the light-emitting element E is formed.

Referring to FIGS. 1 to 7, the light-emitting element E according to an embodiment of the present disclosure may include a vertical cavity surface emitting laser (VCSEL), and the light-emitting element array EA according to an embodiment of the present disclosure may include a VCSEL array.

The light-emitting element array EA may include a plurality of light-emitting elements E arranged two-dimensionally on one base substrate S. For example, in an embodiment of the present disclosure, since the light-emitting element E including a VCSEL emits a Gaussian beam that is closer to a circular light than an edge emitting laser (EEL), it may be relatively easy to shape the shape of light. As described below, the light-emitting element array EA according to an embodiment of the present disclosure may shape light emitted from the light-emitting element E into light that provides an appropriate (preset size) spot size (e.g., radiation angle) and an appropriate (preset range) visual field by disposing an optical lens F on the light-emitting element E.

The light-emitting element E is a laser device including an optically active semiconductor layer (e.g., active layer AR) interposed between a pair of mirror stacks (highly reflective mirror stack, P-type DBR layer, p-DBR and N-type DBR layer, and n-DBR). The mirror stack (P-type DBR layer p-DBR and N-type DBR layer n-DBR) may include a metallic material, a dielectric material, or an epitaxially-grown semiconductor layer, and the optically active semiconductor layer (e.g., active layer AR) may include AlInGaAs or InGaAsP. In an embodiment of the present disclosure, one of the pair of mirror stacks (P-type DBR layer, p-DBR and N-type DBR layer, and n-DBR) is configured to have relatively less reflection than the other, so that coherent light gathered in a resonant cavity formed between the pair of mirror stacks (P-type DBR layer, p-DBR and N-type DBR layer, and n-DBR) and including an active layer AR can be emitted as laser light. In an embodiment of the present disclosure, the light-emitting element E may emit laser light with relatively small beam divergence from the top or bottom surface of the resonant cavity (including the active layer AR), and the light-emitting element E may be arranged one-dimensionally or two-dimensionally on the base substrate S. For example, the light-emitting element E may be formed as different types of a gain-guided light-emitting element or an index-guided light-emitting element. For example, the index-guided light-emitting element is an oxide light-emitting element, and may include an oxide layer (first oxide layer O1) for confining both carriers and light and form an electrical resistance distribution and a refractive index distribution along a transverse direction for carrier confinement and optical confinement by using the oxide layer (first oxide layer O1) surrounding an oxidation aperture OP. In this way, the carrier confinement and the optical confinement along the transverse direction can increase the density of carriers and photons within the active layer AR, and as a result, laser light can be efficiently generated within the active layer AR. In such an embodiment, a confinement region where carrier confinement and optical confinement are performed may be limited to the central region of the light-emitting device E along the transverse direction, and the oxidation aperture OP may limit a current path along which carriers move. In various embodiments of the present disclosure, the oxide layer (the first oxide layer O1) may be formed as a part of a distributed Bragg reflection (DBR) providing the mirror stack (P-type DBR layer, p-DBR and an N-type DBR layer, n-DBR).

In an embodiment of the present disclosure, each of the pair of mirror stacks (P-type DBR layer, p-DBR and an N-type DBR layer, n-DBR) may be formed by alternately stacking layers having different refractive indices and may form a DBR (distributed Bragg reflector) designed for a preferred operating laser wavelength, for example, a wavelength in the range of 650 nm to 1650 nm. For example, each of the pair of mirror stacks (P-type DBR layer, p-DBR and an N-type DBR layer, n-DBR) may be formed by alternately stacking layers each made of high-ratio aluminum-containing AlGaAs and low-ratio aluminum-containing AlGaAs. For example, in an embodiment of the present disclosure, the mirror stack (P-type DBR layer, p-DBR and N-type DBR layer, and n-DBR) may have an effective optical thickness that is approximately ¼ of the operating laser wavelength, and the effective optical thickness may correspond to a value obtained by multiplying the thickness of a corresponding layer by the refractive index of the corresponding layer. In various embodiments of the present disclosure, the pair of mirror stacks (P-type DBR layer, p-DBR and N-type DBR layer, and n-DBR) may be designed so that laser light is emitted from the upper surface of the light-emitting element E, or may be designed so that the laser light is emitted from the bottom surface of the light-emitting element E.

In various embodiments of the present disclosure, the light-emitting element array EA may include a plurality of light-emitting elements E arranged one-dimensionally or two-dimensionally along the base substrate S, and the base substrate S may be made of GaAs, InP, sapphire (Al₂O₃), or InGaAs, and may be undoped, n-type doped (e.g., doped with silicon Si), or p-type doped (e.g., doped with zinc Zn).

In an embodiment of the present disclosure, the light-emitting element array EA may include a plurality of light-emitting elements E each formed with an oxidation aperture OP with substantially the same size along a transverse direction. In an embodiment of the present disclosure, the oxidation aperture OP may be formed through the following process. When the AlGaAs layer is exposed to a high-temperature N2 and H₂O (water vapor) mixed gas atmosphere, H₂O molecules undergo a diffusion process inside the AlGaAs layer, and as a result of a chemical reaction with the AlGaAs material, the AlGaAs material is transforms into an AlO_{X}:As form through an oxidation process. Through such processes, the oxidation aperture may be formed. As conditions for the oxidation process, the Al content of the AlGaAs layer, the H2O (water vapor) content, the temperature of a reaction chamber, or the like may be changed, and the change in the conditions for the oxidation process induce a change in the shape, size, and the like of the oxidation aperture OP in the transverse direction.

A specific one embodiment of the present disclosure is described below. The light-emitting element E may include the base substrate S including first and second surfaces opposite to each other, an N-type distributed Bragg reflector (DBR) layer n-DBR formed on the first surface (upper surface) of the base substrate S, an active layer AR formed on the N-type DBR layer n-DBR, a P-type DBR layer p-DBR formed on the active layer AR, a first electrode contact layer M1 electrically connected to the P-type DBR layer p-DBR, and a second electrode contact layer M2 formed on the second surface (lower surface) of the base substrate S.

More specifically, the N-type DBR layer n-DBR may be formed on the first surface (upper surface) of the base substrate S. In an embodiment of the present disclosure, the N-type DBR layer n-DBR may have a structure in which a pair of AlGaAs layers having different compositions are alternately formed or in which a GaAs layer and an AlGaAs layer are alternately stacked. In an embodiment of the present disclosure, the N-type DBR layer n-DBR may include a pair of AlGaAs layers alternately stacked, and any one of the pair of AlGaAs layers may have a relatively higher aluminum (Al) composition than the other. For example, the pair of AlGaAs layers may include an Al_{0.92}Ga_{0.08}As layer and an Al_{0.16}Ga_{0.84}As layer. The N-type DBR layer n-DBR may be doped with n-type by including silicon (Si) as an impurity.

The N-type DBR layer n-DBR may perform an internal reflection function under the active layer AR, and also supply n-type carriers to the active layer AR. The active layer AR and the P-type DBR layer p-DBR may be formed on the N-type DBR layer n-DBR.

The active layer AR may include AlInGaAs (i.e., AlInGaAs, GaAs, AlGaAs, and InGaAs), InGaAsP (i.e., InGaAsP, GaAs, InGaAs, GaAsP, and GaP), GaAsSb (i.e., GaAsSb, GaAs, and GaSb), InGaAsN (i.e., InGaAsN, GaAs, InGaAs, GaAsN, and GaN), or AlInGaAsP (i.e., AlInGaAsP, AlInGaAs, AlGaAs, InGaAsP, GaAs, InGaAsP, GaAs, InGaAs, GaAsP, and GaP), or alternatively, may also include a quantum well layer composition. In various embodiments of the present disclosure, the active layer AR may include one or more quantum well layers and barrier layers, and the quantum well layers may include any one of GaAs, AlGaAs, AlGaAsSb, InAlGaAs, AlInGaP, GaAsP, and InGaAsP, and the barrier layer may include any one of AlGaAs, InAlGaAs, InAlGaAsP, AlGaAsSb, GaAsP, GaInP, AlInGaP, and InGaAsP.

The P-type DBR layer p-DBR may be formed on the active layer AR. The P-type DBR layer p-DBR may be formed by alternately stacking a pair of AlGaAs layers having different compositions or by alternately stacking a GaAs layer and an AlGaAs layer. In an embodiment of the present disclosure, the P-type DBR layer p-DBR may include a pair of AlGaAs layers alternately stacked, and any one of the pair of AlGaAs layers may have a relatively higher aluminum (Al) composition than the other. For example, the pair of AlGaAs layers may include an Al_{0.92}Ga_{0.08}As layer and an Al_{0.16}Ga_{0.84}As layer. In an embodiment of the present disclosure, the P-type DBR layer p-DBR may be doped with p-type by including carbon (C) or zinc (Zn) as an impurity.

A first oxide layer O1 defining an oxidation aperture OP may be formed within the P-type DBR layer p-DBR. In an embodiment of the present disclosure, the first oxide layer O1 may be formed on the base substrate S at a position adjacent to the active layer AR along the stacking direction in which the N-type DBR layer n-DBR, the active layer AR, and the P-type DBR layer p-DBR are stacked. The fact that the first oxide layer O1 is formed at a position adjacent to the active layer AR may mean that the first oxide layer O1 is formed at a position relatively closer to the active layer AR in the entire height of the P-type DBR layer p-DBR along the stacking direction. For example, the first oxide layer O1 may mean that out of the upper surface of the P-type DBR layer p-DBR adjacent to the first electrode contact layer M1 and the lower surface of the P-type DBR layer p-DBR adjacent to the active layer AR, the first oxide layer O1 is formed at a position closer to the lower surface of the P-type DBR layer p-DBR.

The first oxide layer O1 may confine carriers in the transverse direction. The carrier confinement may be performed by the first oxide layer O1 formed with a relatively high electrical resistance to restrict the migration of carriers. The first oxide layer O1 may surround the oxidation aperture OP and allow carriers to preferentially move through the oxidation aperture OP. For example, an electrical resistance distribution and a refractive index distribution may be formed along the transverse direction through the first oxide layer O1 surrounding the oxidation aperture OP, and the density of carriers and photons may be increased within the active layer AR by carrier confinement and optical confinement, and as a result, laser light may be efficiently generated within the active layer AR.

In an embodiment of the present disclosure, the first oxide layer O1 surrounding the oxidation aperture OP may be formed through the same process as the oxidation aperture OP. As conditions for the oxidation process, the Al content of the AlGaAs layer, the H2O (water vapor) content, the temperature of a reaction chamber, or the like may be changed, and the change in the conditions for the oxidation process induce a change in the shape, size, and the like of the oxidation aperture OP in the transverse direction.

In an embodiment of the present disclosure, in the oxidation process, in addition to the first oxide layer O1 surrounding the oxidation aperture OP, a second oxide layer O2 may be formed inside the P-type DBR layer p-DBR. For example, in an embodiment of the present disclosure, in the P-type DBR layer p-DBR in which a relatively high-ratio aluminum-containing AlGaAs layer and a relatively low-ratio aluminum-containing AlGaAs layer are alternately stacked, the second oxide layer O2 including oxide layers having different oxidation distances d2 and d3 may be alternately formed along the stacking direction. For example, in an embodiment of the present disclosure, the oxidation distances d1 to d3 may mean distances extending from an etched portion ET formed on an exposed region or an exposed side surface of the light-emitting element E toward a central region of the light-emitting element E, as described below. For example, the oxidation distance d2 of the high-ratio aluminum-containing AlGaAs layer may extend inwardly toward the central region of the light-emitting element E longer than the oxidation distance d3 of the low-ratio aluminum-containing AlGaAs layer.

Although not illustrated in the drawing, in an embodiment of the present disclosure, the first oxide layer O1 surrounding the oxidation aperture OP may include a plurality of holes (not illustrated) for exposing a region of the first oxide layer O1 within the P-type DBR layer p-DBR. In such a case, as heated water vapor penetrates through the side surface of an exposed hole (not illustrated) and oxidizes the oxidation aperture OP, the first oxide layer O1 surrounding the oxidation aperture OP may be formed. The hole for exposing the side surface may be formed to the depth of the region of the first oxide layer O1 in the P-type DBR layer p-DBR. When the light-emitting element E is exposed to the heated water vapor in the oxidation process, the heated water vapor enters the hole and is diffused radially from the hole (not illustrated). When the heated water vapor is diffused from each hole, the oxidation treatment may be continued until oxidation interfaces are merged with each other and the oxidation aperture OP is formed.

In an embodiment of the present disclosure, the light-emitting element E may include an ion implantation layer P for blocking defect migration within the light-emitting element E. More specifically, the formation or migration of defects within the light-emitting element E may increase optical absorption in the P-type DBR layer p-DBR and the N-type DBR layer n-DBR or deteriorate electro-optic properties in the active layer AR. In an embodiment of the present disclosure, defects or defect sources that may cause performance deterioration of the light-emitting element E may include an oxide layer (second oxide layer O2) of the light-emitting element E and an etched portion ET formed in an exposed region of the light-emitting element E. For example, when the AlGaAs layer is exposed to a high-temperature N₂ and H₂O (water vapor) mixed gas atmosphere, H₂O (water vapor) molecules undergo a diffusion process within the AlGaAs layer. Accordingly, the oxide layer (second oxide layer O2) may form a compressive strain field by inducing compressive strain due to a volume reduction caused by the AlGaAs material being transformed into the AlOX:As form.

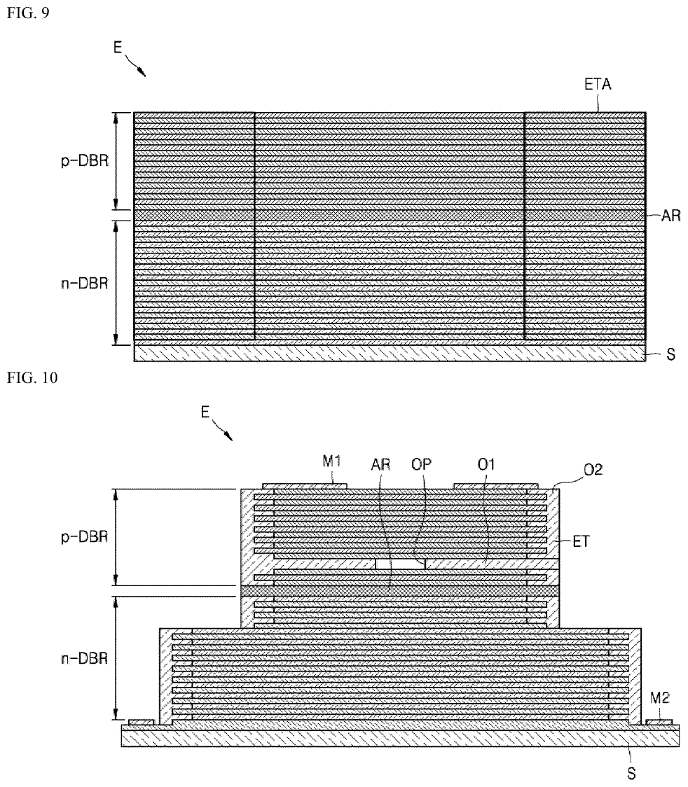

In an embodiment of the present disclosure illustrated in FIG. 4, the light-emitting element E may be formed in a double-sided contact form in which the first and second electrode contact layers M1 and M2 different from each other are formed from the first and second surfaces of the base substrate S, respectively. For example, the P-type DBR layer p-DBR and the N-type DBR layer n-DBR adjacent to the P-type DBR layer p-DBR may be etched down to have a step with the N-type DBR layer n-DBR formed on the base substrate S or the first surface of the base substrate S (for example, an etched area ETA illustrated in FIG. 5). In such a case, the side surface of the P-type DBR layer p-DBR may correspond to an etched portion ET formed in the exposed region as a defect or defect source of the light-emitting element E. As illustrated in FIG. 8, the light-emitting element E according to another embodiment of the present disclosure may be formed in a front contact form in which both the first and second electrode contact layers M1 and M2 different from each other are formed on the first surface (upper surface) of the base substrate S. Both the P-type DBR layer p-DBR and the N-type DBR layer n-DBR may be etched down to form a step structure from the base substrate S (for example, an etched area ETA illustrated in FIG. 9), and the side surface of the P-type DBR layer p-DBR and the N-type DBR layer n-DBR may correspond to an etched portion ET formed in the exposed region as a defect or defect source of the light-emitting element E. In such an embodiment, the first and second electrode contact layers M1 and M2 connected to the P-type DBR layer p-DBR and the N-type DBR layer n-DBR, respectively, may be formed from the first surface (upper surface) of the base substrate S on the P-type DBR layer p-DBR and the base substrate S, respectively.

For example, the etched portion ET may include a lattice defect of a crystal lattice or a defect induced by a residual film after etching. For example, the etched portion ET may include, as a lattice defect, a line defect such as a dislocation or a point defect such as a vacancy, and may include a defect induced by a residual film after etching.

For example, as a defect or a defect source causing performance deterioration of the light-emitting element E, an oxide layer (second oxide layer O2) or an etched portion ET may induce strain or stress in the structure of the light-emitting element E, and such a defect may cause defect migration toward the active layer AR during the operation of the light-emitting element E.

In an embodiment of the present disclosure, in order to block defect migration, the light-emitting element E may include an ion implantation layer P in order to insulate or non-conduct a defect or a defect source. In an embodiment of the present disclosure, the ion implantation layer P may be formed by an ion implantation method in which a mask (not illustrated) provided with an aperture pattern is placed and an ion beam including ion species is accelerated and projected onto a region corresponding to the aperture pattern of the mask (not illustrated), and the implantation depth PD of the ion species or the depth PD of the ion implantation layer P may be adjusted depending on the weight of the ion species to be implanted or the amount of energy used to accelerate the ion beam. In an embodiment of the present disclosure, in the ion implantation for forming the ion implantation layer P, ion species such as H+, O+, N+, or F+may be applied and for example, protons (H+) may be applied.

The ion implantation may induce lattice defects such as vacancy in the ion implantation layer P through ion implantation, thereby insulating or non-conducting the ion implantation layer P. Accordingly, the migration of current or carriers toward a defect source covered by the ion implantation layer P, for example, a defect source such as an oxide layer (second oxide layer O2) and an etched portion ET, may be suppressed, and defect migration from the defect source such as an oxide layer (second oxide layer O2) and an etched portion ET may be suppressed.

In an embodiment of the present disclosure, the implantation depth PD into which ion species are implanted in ion implantation or the depth PD of the ion implantation layer P may be set to at least a lower region of the active layer AR that is out of the depth of the active layer AR. The implantation width into which ion species are implanted along the transverse direction, the width of the aperture pattern into which ion species are implanted through the mask, or the width of the ion implantation layer P may be formed wider than the oxidation distance (d2/d3, oxidation distance d2/d3 of the second oxide layer O2, for example, a relatively long oxidation distance d2/d3 out of different oxidation distances d2/d3 of the second oxide layer O2) of the P-type DBR layer p-DBR and narrower than the first electrode contact layer M1 formed on the P-type DBR layer p-DBR. In other words, the implantation width into which ion species are implanted or the width of the ion implantation layer P may be formed to be wide enough to completely cover the oxidation distance (d2/d3, a relatively long oxidation distance d2/d3 out of different oxidation distances d2/d3 of the second oxide layer O2) of the P-type DBR layer p-DBR, while being formed to be narrow enough to cover only a part of the first electrode contact layer M1 to allow an Ohmic contact of the first electrode contact layer M1. In an embodiment of the present disclosure, the width of the ion implantation layer P may be formed to be narrow enough to cover only an edge region of the first oxide layer O1 surrounding the oxidation aperture OP in the central region, and not to cover the central region of the first oxide layer O1 adjacent to the oxidation aperture OP (since the oxidation aperture OP in the central region is a region for carrier confinement), and the etched portion ET and the second oxide layer O2 formed in the edge region may be formed to be wide enough to cover the entirety. For example, the ion implantation layer P may be formed in the edge region of the light-emitting element E, and may cover the etched portion ET formed in the edge region of the light-emitting element E, the entire second oxide layer O2, and the edge region being a part of the first oxide layer O1, but may not cover the central region of the first oxide layer O1 surrounding the oxidation aperture OP. For example, for carrier confinement, the ion implantation layer P may not cover the oxidation aperture OP formed in the central region of the light-emitting element E and the central region of the first oxide layer O1 adjacent to the oxidation aperture OP.

In this way, the width of the ion implantation layer P or the width into which ion species are implanted may be formed to be sufficiently narrow so as not to cover the oxidation aperture OP for carrier confinement and optical confinement and the active layer AR (for example, the central region of the active layer AR) where the density of carriers and photons is increased by the oxidation aperture OP. More specifically, the width of the ion implantation layer P for blocking defect migration or the implantation width into which ion species are implanted may be defined between the inner end and the outer end of the ion implantation layer P or the implantation width along the transverse direction. The inner end and the outer end of the ion implantation layer P or the implantation width may mean the inner end of the ion implantation layer P, which is relatively close to the central region of the light-emitting element E or the oxidation aperture OP formed in the central region, or the implantation width, and the outer end of the ion implantation layer P, which is relatively far from the central region or the oxidation aperture OP formed in the central region, or the implantation width, respectively. In an embodiment of the present disclosure, the ion implantation layer P or the implantation width may be formed from the outer end covering the etched portion ET formed in the exposed region of the light-emitting element E to the inner end between the outer end of the first electrode contact layer M1 and the inner end of the first electrode contact layer M1. In other words, the ion implantation layer P or the implantation width may be formed to cover a part of the first electrode contact layer M1 along the transverse direction, but not to cover the entire first electrode contact layer M1. In an embodiment of the present disclosure, the inner end of the ion implantation layer P or the implantation width may be formed between the inner end of the second oxide layer O2 and the inner end of the first oxide layer O1 (or oxidation aperture OP defined by the inner end of the first oxide layer O1). Accordingly, the ion implantation layer P or the implantation width may be formed to cover the entire second oxide layer O2 along the transverse direction while covering only a part of the first oxide layer O1. On the other hand, in an embodiment of the present disclosure, the outer end of the ion implantation layer P or the implantation width may be formed at an end position of the P-type DBR layer p-DBR that is stepped inwardly along the transverse direction from the N-type DBR layer n-DBR stacked on the base substrate S or an end position of the N-type DBR layer n-DBR adjacent to the P-type DBR layer p-DBR.

In an embodiment of the present disclosure, the ion implantation layer P or the implantation width may be formed from the outer end covering the etched portion ET formed in the exposed region of the light-emitting element E to the inner end not reaching the oxidation aperture OP. The oxidation aperture OP may be formed at a position not overlapping the ion implantation layer P or the implantation width so as to be completely out of the ion implantation layer P or the implantation width. In order to prevent the conductive characteristics of the oxidation aperture OP for carrier confinement and optical confinement or the central region of the active layer AR adjacent to the oxidation aperture OP from being deteriorated by the ion implantation layer P or the ion implantation for forming the ion implantation layer P, the ion implantation layer P or the central region of the active layer AR corresponding to the oxidation aperture OP along the transverse direction may be formed at a position completely out of the ion implantation layer P or the implantation width.

In an embodiment of the present disclosure, the width of the ion implantation layer P for suppressing defect migration from a defect source such as an oxide layer (second oxide layer O2) and an etched portion ET toward an active layer AR (for example, the central region of the active layer AR where carrier confinement and optical confinement are performed by the oxidation aperture OP) or the implantation width, into which ion species are implanted in the ion implantation, may be formed to expose the central region of the active layer AR but cover the edge region of the active layer AR adjacent to the oxide layer (second oxide layer O2) and the etched portion ET. For example, when defect migration occurs from the defect source such as the oxide layer (second oxide layer O2) and the etched portion ET to the central region of the active layer AR or a position adjacent to the central region, the performance of the light-emitting element E may rapidly deteriorate, causing the function of the light-emitting element E to be substantially lost. Accordingly, in an embodiment of the present disclosure, even though the conductive properties of a part of the active layer AR (edge region of the active layer AR) are deteriorated or a part of the active layer AR (edge region of the active layer AR) is insulated or non-conducted due to the ion implantation or the ion implantation layer P formed from the ion implantation, it is possible to form an implantation width or the ion implantation layer P covering the edge region of the active layer AR adjacent to the defect source such as the oxide layer (second oxide layer O2) and the etched portion ET so that defect migration is blocked. In an embodiment of the present disclosure, the depth PD of the ion implantation layer P or the implantation depth PD may be set to the lower region of the active layer AR, and considering the depth PD of the ion implantation layer P or the implantation depth PD that is set deep to the lower region of the active layer AR, the ion implantation layer P may cover the edge region of the light-emitting element E in which the second oxide layer O2 or the etched portion ET corresponding to a defect or a defect source is formed, while also covering the edge region of the active layer AR.

In an embodiment of the present disclosure, the depth PD of the ion implantation layer P or the implantation depth PD into which ion species are implanted in the ion implantation may mean a depth at which an accelerated ion beam is projected, and may not include, for example, a depth at which the ion species projected into the light-emitting element E are diffuse after the projection. Similarly, the width of the ion implantation layer P or the implantation width into which the ion species are implanted in the ion implantation may mean a width at which an accelerated ion beam is projected into the light-emitting element through the aperture pattern of the mask (not illustrated). For example, a width at which the ion species projected into the light-emitting element E are diffused after the projection.

In an embodiment of the present disclosure, the depth PD of the ion implantation layer P or the implantation depth PD into which ion species are implanted in the ion implantation for blocking defect migration may be set to a sufficient depth at least to the lower region of the active layer AR out of the active layer AR. A defect may be induced in a part of the active layer AR (the edge region of the active layer AR) through the ion implantation layer P formed to a sufficient depth including the active layer AR and the lower region of the active layer AR. However, when the defect migration from the oxide layer (second oxide layer O2) and the etching section ET progresses to the active layer AR (for example, the central region of the active layer AR where carrier confinement and optical confinement occur by the oxidation aperture OP), the function of the light-emitting element E may be substantially lost due to rapid deterioration of the active layer AR. Accordingly, even though a part of the active layer AR (the edge region of the active layer AR) is insulated or non-conducted by the ion implantation layer P covering a part of the active layer AR (the edge region of the active layer AR), the ion implantation layer P or the implantation depth PD of ion implantation may be set to a sufficient depth at least the lower region of the active layer AR beyond the active layer AR in consideration of the stable driving of the light-emitting element E over time in an embodiment of the present disclosure.

In a comparative example compared with the present disclosure, the first oxide layer O1 surrounding the oxidation aperture OP is formed as follows. A mask (not illustrated) having an aperture pattern corresponding to the oxidation aperture OP is arranged, and ion implantation is performed to accelerate and project an ion beam including ion species onto a region corresponding to the aperture pattern, thereby forming the oxidation aperture OP for carrier confinement and optical confinement. In a comparative example where ion implantation is applied to the formation of the oxidation aperture OP for carrier confinement and optical confinement (formation of the first oxide layer O1 surrounding the oxidation aperture OP), the implantation depth PD into which ion species are implanted or the implantation depth PD into which an accelerated ion beam is projected may be limited to a depth not reaching the active layer AR. In contrast, in an embodiment of the present disclosure where ion implantation is applied to suppress defect migration from the defect source such as the oxide layer (second oxide layer O2) or the etched portion ET toward the active layer AR (central region of the active layer AR where carrier confinement and optical confinement occur), the implantation depth PD (or the depth PD of the ion implantation layer P) of the ion implantation may be formed to a sufficient depth at least to the lower region of the active layer AR out of the active layer AR. As in the comparative example, in the ion implantation for forming the oxidation aperture OP and the first oxide layer O1 surrounding the oxidation aperture OP, the width of the aperture pattern of the mask (not illustrated) on which an ion beam including ion species is projected may be set with the center region, which corresponds to the oxidation aperture OP formed in the central region along the transverse direction, as the center. For example, as can be seen from FIG. 4, when the oxidation aperture OP is a structure formed inside the inner end of the first electrode contact layer M1, a position where the conductivity is lost due to a defect in the ion implantation for forming the first oxide layer O1 surrounding the oxidation aperture OP may correspond to the inner position of the light-emitting element E (central region of the light-emitting element E) along the transverse direction (such as a position inside the inner end of the first electrode contact layer M1). In this way, in the comparative example where the ion implantation position is set to a relatively central region, the implantation depth PD of the ion implantation may be set to a relatively thin depth not reaching the active layer AR so that the central region of the active layer AR where carrier confinement and optical confinement occur is not insulated or non-conducted.

In other words, in the comparative example where the ion implantation is applied to form the oxidation aperture OP, the implantation depth PD may be set to a relatively thin depth not reaching the active layer AR, thereby preventing the central region of the active layer AR from being insulated or non-conducted due to deterioration of conductive characteristics or loss of conductivity by lattice defects. Accordingly, in the comparative example, the implantation depth PD into the ion species are implanted or the implantation depth PD into the ion species is projected may be limited to the upper region of the active layer AR.

Unlike such comparative examples, in an embodiment of the present disclosure, the ion implantation is performed by setting the implantation width or the width of the ion implantation layer P to completely expose the central region of the active layer AR, so that the central region of the active layer AR is not deteriorated by the ion implantation, and even though the implantation depth PD is set to a sufficient depth to the lower region of the active layer AR, the central region of the active layer AR may not be deteriorated. In addition, the implantation depth PD of the ion implantation may be set a sufficient depth to the lower region of the active layer AR so that the edge region of the active layer AR adjacent to the defect source (such as the oxide layer (second oxide layer O2) and the etched portion ET) is insulated or non-conducted by a defect (lattice defect such as vacancy) induced by the ion implantation.

In an embodiment of the present disclosure, the oxidation aperture OP may be formed from a separate oxidation process prior to the ion implantation for suppressing defect migration. For example, in the oxidation process for forming the oxidation aperture OP, oxide layers (second oxide layers O2) having different oxidation distances d2 and d3 may be alternately formed along the stacking direction according to the aluminum content of layers (e.g., a P-type DBR layer and a sub-layer forming p-DBR) that are stacked with respect to each other to form a P-type DBR layer p-DBR. For example, in the oxidation process, heated water vapor may be diffused into the interior of the light-emitting element E and react with the P-type DBR layer p-DBR to form the second oxide layer O2 of the P-type DBR layer p-DBR. In addition, as the heated water vapor is radially diffused through the exposed side surface of a hole (not illustrated) formed in the P-type DBR layer p-DBR, oxidation interfaces may be merged with each other to form the first oxide layer O1 surrounding the oxidation aperture OP. In an embodiment of the present disclosure, the oxidation distances d1 to d3 of the first and second oxide layers O1 and O2 or the diffusion distance of the heated water vapor are determined by the aluminum content of layers forming the first and second oxide layers O1 and O2 or a separate diffusion promoting structure such as a hole (not illustrated) that promotes diffusion of the heated water vapor. The first and second oxide layers O1 and O2 are formed within the P-type DBR layer p-DBR, where the first oxide layer O1 may be formed with a relatively long first oxidation distance d1 to the central region of the light-emitting element E so as to surround the oxidation aperture OP, and the second oxide layer O2 may be formed with a relatively short oxidation distance d2 limitedly to the edge region of the light-emitting element E. For example, in an embodiment of the present disclosure, the second oxide layer O2 may have different second and third oxidation distances d2 and d3 along the stacking direction, and may have different second and third oxidation distances d2 and d3 depending on the aluminum content of layers (sublayer forming the P-type DBR layer) alternately stacked with respect to each other. In an embodiment of the present disclosure, the first to third oxidation distances d1 to d3 may be measured from an edge region corresponding to an exposed region of the light-emitting element E. The first oxidation distance d1 of the first oxide layer O1 surrounding the oxidation aperture OP may be formed to be the longest, the second and third oxidation distances d2 and d3 of the second oxide layer O2 may be formed to be relatively shorter than the first oxidation distance d1, and the second oxidation distance d2 may be formed to be relatively longer than the third oxidation distance d3 depending on the aluminum content of alternately stacked layers.

In an embodiment of the present disclosure, the first to third oxidation distances d1 to d3 of the P-type DBR layer p-DBR and the width of the ion implantation layer P for suppressing defect migration or the implantation width of the ion implantation may have the following magnitude relationship. That is, when measured from the edge of the light-emitting element E forming the exposed region of the light-emitting element E, the magnitude relationship between the first to third oxidation distances d1 to d3 and the implantation width from the edge toward the central region may satisfy the relationship of first oxidation distance d1>width of the ion implantation layer P or implantation width>second oxidation distance d2>third oxidation distance d3. In other words, in an embodiment of the present disclosure, the implantation width of the ion implantation for suppressing defect migration may be formed to sufficiently cover the second and third oxidation distances d2 and d3 while covering only the edge region of the first oxidation distance d1 and exposing the central region without covering the central region.

In an embodiment of the present disclosure, the depth PD of the ion implantation layer P for suppressing defect migration or the implantation depth PD into which ion species are implanted may be formed to the lower region of the active layer AR beyond the active layer AR. For example, it may be set to extend beyond the active layer AR to a part (the N-type DBR layer, the upper portion of the n-DBR) of the N-type DBR layer n-DBR below the active layer AR. In an embodiment of the present disclosure, the depth PD of the ion implantation layer P or the implantation depth PD may be set to a thinner (shallower) depth than the depth (see FIG. 5) of the etching down. When the depth PD of the ion implantation layer P or the implantation depth PD is formed deeper than the depth of the etching down, lattice defects (such as vacancy due to ion implantation) may be induced inside the N-type DBR layer n-DBR that is relatively far from defect sources (such as the oxide layer (second oxide layer O2) and the etched portion ET). This may unnecessarily induce defects due to ion implantation in the N-type DBR layer n-DBR where the problems of recombination of minority carriers due to defects or reduction in the lifetime of minority carriers are relatively less serious than in the P-type DBR layer p-DBR where such problems are relatively serious. For example, in an embodiment of the present disclosure, the depth of the etching down may mean a depth encompassing the P-type DBR layer p-DBR stepped inwardly along the transverse direction of the base substrate S from the N-type DBR layer n-DBR stacked on the base substrate S and the N-type DBR layer n-DBR adjacent to the P-type DBR layer p-DBR and stepped inwardly together with the P-type DBR layer p-DBR.

In an embodiment of the present disclosure, since the implantation depth PD into which ion species are implanted may be set to the lower region of the active layer AR, for example, it may be formed up to the N-type DBR layer n-DBR formed under the active layer AR, and may be set to a thinner (shallower) depth than the depth of the etching down of the N-type DBR layer n-DBR stepped inwardly together with the P-type DBR layer p-DBR.

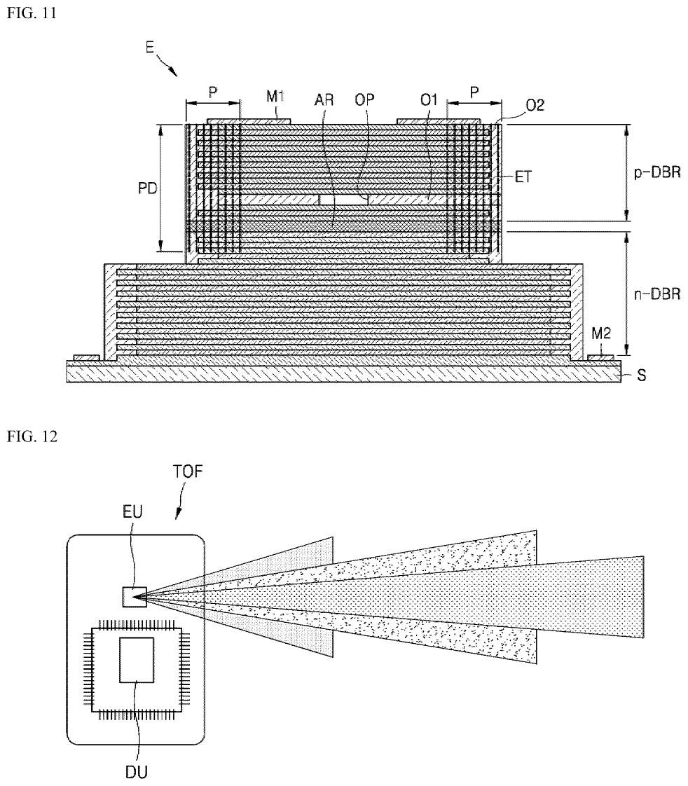

FIG. 8 is a view illustrating the cross-sectional structure of a light-emitting element E according to another embodiment of the present disclosure. FIGS. 9 to 11 are views illustrating the cross-sectional structure of the light-emitting element E illustrated in FIG. 8 at different phases in which the light-emitting element E is formed.

Referring to FIGS. 8 to 11, the light-emitting element E according to another embodiment of the present disclosure may be formed in a front contact form in which different first and second electrode contact layers M1 and M2 are both formed from a first surface (upper surface) of a base substrate S. Both the P-type DBR layer p-DBR and the N-type DBR layer n-DBR may be etched down so that both the P-type DBR layer p-DBR and the N-type DRB layer form a step structure from the base substrate S (see an etched area ETA in FIG. 9). In such an embodiment, an etched portion ET may be formed in both the exposed regions of the P-type DBR layer p-DBR and the N-type DBR layer n-DBR, and second oxide layers O2 may be formed alternately stacked with different oxidation distances d2 and d3 from the etched portion ET. For example, the N-type DBR layer n-DBR may be formed by alternately stacking layers including a high-ratio aluminum-containing AlGaAs layer and a low-ratio aluminum-containing AlGaAs layer along the stacking direction, and the second oxide layers O2 may have different oxidation distances depending on the different aluminum content. In the N-type DBR layer n-DBR, the problems of recombination of minority carriers due to defects or reduction in the lifetime of minority carriers are relatively less serious than the P-type DBR layer p-DBR, and the N-type DBR layer n-DBR has no significantly influence on the performance deterioration of the light-emitting element E. Accordingly, even though the etched portion ET and the second oxide layer O2 are formed in the exposed region of the N-type DBR layer n-DBR, in an embodiment of the present disclosure, no ion implantation layer P covering the etched portion ET and the second oxide layer O2 of the N-type DBR layer n-DBR may be formed.

Referring to FIGS. 1 to 3, in an embodiment of the present disclosure, the light-emitting element array EA may include the plurality of light-emitting elements E arranged laterally along one base substrate S. A passivation I including polyimide or the like may be formed between adjacent light-emitting elements E along the arrangement of the light-emitting elements E. In the present specification, the exposed region of the light-emitting element E may mean the boundary of the P-type DBR layer p-DBR or the N-type DBR layer n-DBR of the light-emitting element E, and may include, for example, the boundary between the passivation I and the P-type DBR layer p-DBR interposed between adjacent light-emitting elements E, and the boundary between the passivation I and the N-type DBR layer n-DBR interposed between adjacent light-emitting elements E.

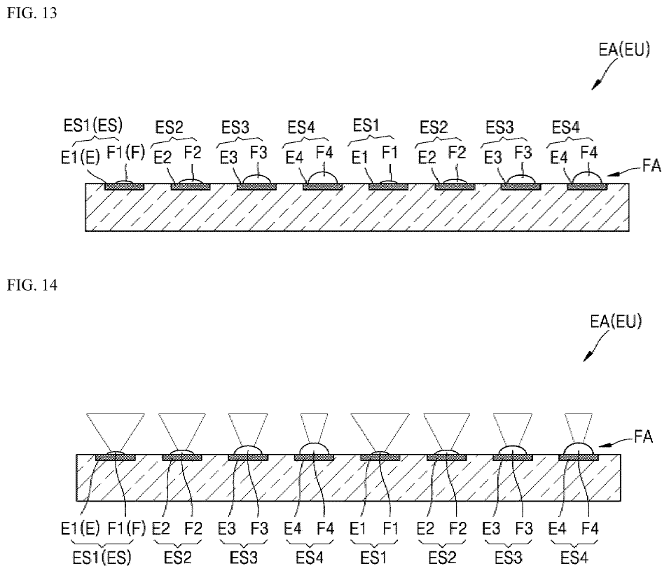

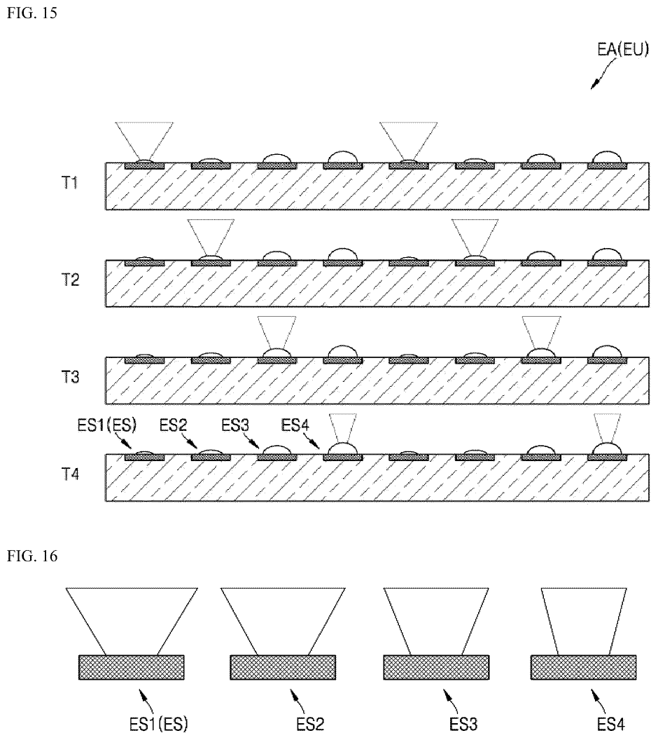

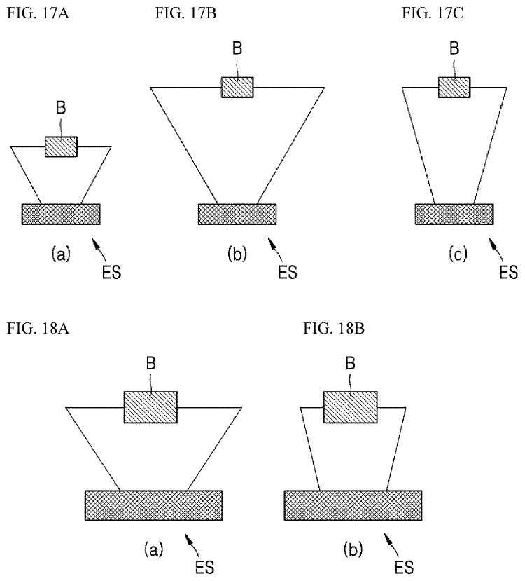

FIG. 12 is a view schematically illustrating the structure of a TOF sensor TOF including a light-emitting unit EU including the plurality of light-emitting elements E and a light-receiving unit DU including a plurality of light-receiving elements. FIG. 13 is a view illustrating the cross-sectional structure of a light-emitting unit EU including an optical lens array FA arranged on a light-emitting element array EA in an embodiment of the present disclosure. FIG. 14 is a view exemplarily illustrating the forms of lights emitted from the light-emitting unit EU illustrated in FIG. 13 and providing different spot sizes (different radiation angles) and visual fields. FIG. 15 is a view illustrating a form in which lights providing different spot sizes (different radiation angles) and visual fields are sequentially output in a phase in which a light-emitting element assembly ES1 of a first group to a light-emitting element assembly ES4 of a fourth group in the light-emitting unit EU illustrated in FIG. 13 are sequentially driven, for example, at different times T1 to T4. FIG. 16 is a view illustrating a comparison of the forms of lights emitted from the light-emitting element assemblies ES1 to ES4 of the first to fourth groups in the light-emitting unit EU illustrated in FIG. 13 and providing different spot sizes (different radiation angles) and visual fields. FIG. 17A-17C are views for explaining a configuration for sensing a distant object, a configuration for increasing light intensity with the same spot size, and a configuration for reducing the spot size of light. FIGS. 18A and 18B are views for explaining a configuration for increasing sensitivity with the same light intensity.

Referring to FIGS. 12 to 18B, in an embodiment of the present disclosure, the light-emitting element array EA or the light-emitting unit EU including the light-emitting element array EA detects a transmission time of light emitted from the light-emitting element array EA or the light-emitting unit EU and a light reception time when reflected light reflected from a surrounding object B is detected by the light-receiving unit DU including a plurality of light-receiving elements. The light-emitting unit EU may form a time of flight (TOF) sensor TOF capable of detecting a distance and a position with respect to the surrounding object B according to a light flight distance. That is, the TOF sensor TOF may include the light-emitting unit EU including the light-emitting element array EA and the light-receiving unit DU including the plurality of light-receiving elements. The TOF sensor TOF according to an embodiment of the present disclosure may include a light-emitting unit (EU or light-emitting element E) that emits light toward a visual field around the sensor, and a light-receiving unit (DU or light-receiving element) for sensing reflected light from the surrounding object B. The TOF sensor TOF may further include an operation processing unit (not illustrated) for calculating, from a transmission time of light from the light-emitting unit EU and a reception time of light reflected from the surrounding object B and sensed by the light-receiving unit DU, a light flight time corresponding to a time difference between the transmission time of the light and the reception time of the light and calculating a distance to the surrounding object B from the calculated light flight time. As described below, the light-emitting unit EU may include a light-emitting element array EA including a plurality of light-emitting elements E and an optical lens array FA including a plurality of optical lenses F arranged on the light-emitting element array EA. Technical details regarding the optical lenses F or the optical lens array FA are described below in more detail.

In an embodiment of the present disclosure, the light-emitting element array EA may include light-emitting elements E1 to E4 of first to fourth groups respectively arranged in rows, and optical lenses F1 to F4 of first to fourth groups may be arranged on the light-emitting elements E1 to E4 of first to fourth groups, respectively, to shape lights emitted from the light-emitting elements E into different shapes. In an embodiment of the present disclosure, the light-emitting elements E1 to E4 of the first to fourth groups may refer to one group of light-emitting elements E that are electrically connected to each other and share an address line A that supplies power to drive them together, and similarly, the optical lenses F1 to F4 of the first to fourth groups may refer to one group of optical lenses F respectively arranged on the light-emitting elements E1 to E4 of the first to fourth groups, which share the address line A. The light-emitting elements E1 to E4 of the first to fourth groups and the optical lenses F1 to F4 of the first to fourth groups may have the same arrangement on the base substrate S. The light-emitting element array EA and the optical lens array FA arranged on the light-emitting element array EA may form the light-emitting unit EU, and each light-emitting element E and the optical lens F arranged on the light-emitting element E can form a light-emitting element assembly ES. In this sense, the light-emitting unit EU according to an embodiment of the present disclosure may include the light-emitting elements E1 to E4 of the first to fourth groups, may include optical lenses F1 to F4 of the first to fourth groups together with the light-emitting elements E1 to E4 of the first to fourth groups, and may also include light-emitting element assemblies ES1 to ES4 of first to fourth groups, each including the light-emitting element E and the optical lens F.

In an embodiment of the present disclosure, the light-emitting unit EU may include the light-emitting element assembly ES1 of the first group, the light-emitting element assembly ES2 of the second group, the light-emitting element assembly ES3 of the third group, and the light-emitting element assembly ES4 of the fourth group, which emit lights shaped into different shapes to provide different spot sizes and visual fields. In an embodiment of the present disclosure, the fact that the light-emitting unit EU includes the light-emitting element assembly ES1 of the first group, the light-emitting element assembly ES2 of the second group, the light-emitting element assembly ES3 of the third group, and the light-emitting element assembly ES4 of the fourth group, which emit lights shaped into different shapes may mean that they emit different lights shaped with different radiation angles to have different spot sizes at the same optical axis distance along an optical axis or emit lights differently shaped with different spot sizes to have different light intensities at the same optical axis distance along the optical axis.

As described below, the light-emitting element assembly ES1 of the first group may include the light-emitting element E1 of the first group and the optical lens F1 of the first group disposed on the optical axes of the light-emitting element E1 of the first group, and the light-emitting element assembly ES2 of the second group may include the light-emitting element E2 of the second group and the optical lens F2 of the second group disposed on the optical axes of the light-emitting element E2 of the second group. Similarly, the light-emitting element assembly ES3 of the third group may include the light-emitting element E3 of the third group and the optical lens F3 of the third group disposed on the optical axes of the light-emitting element E3 of the third group, and the light-emitting element assembly ES4 of the fourth group may include the light-emitting element E4 of the fourth group and the optical lens F4 of the fourth group disposed on the optical axes of the light-emitting element E4 of the fourth group.

In an embodiment of the present disclosure, the light-emitting elements E1 to E4 of the first to fourth groups may have substantially the same structure and the same performance, and the optical lenses F1 to F4 of the first to fourth groups may shape lights emitted from the light-emitting elements E1 to E4 of the first to fourth groups into different shapes.

In an embodiment of the present disclosure, the light-emitting element assembly ES1 of the first group senses the position of the surrounding object B captured in the near visual field around the TOF sensor TOF according to the distance to the surrounding object B to be captured by the light-emitting unit EU or the TOF sensor TOF including the light-emitting unit EU. The light-emitting element assembly ES4 of the fourth group senses the position of the surrounding object B captured in the far visual field around the TOF sensor TOF. The light-emitting element assemblies ES2 and ES3 of the second and third groups provide an intermediate visual field that is longer than the near visual field of the light-emitting element assembly ES1 of the first group and shorter than the far visual field of the light-emitting element assembly ES4 of the fourth group between the near visual field and the far visual field around the TOF sensor TOF, depending on the distance from the surrounding object B to be captured by the TOF sensor TOF. For example, the visual field of the light-emitting element assembly ES2 of the second group may be set between the near visual field and the far visual field of the light-emitting element assemblies ES1 and ES4 of the first and fourth groups, while providing a near visual field that is closer to the near visual field of the light-emitting element assembly ES1 of the first group than the far visual field of the light-emitting element assembly ES4 of the fourth group. The visual field of the light-emitting element assembly ES3 of the third group may be set between the near visual field and the far visual field of the light-emitting element assemblies ES1 and ES4 of the first and fourth groups, while providing a far visual field that is closer to the far visual field of the light-emitting element assembly ES4 of the fourth group than the near visual field of the light-emitting element assembly ES1 of the first group.

In an embodiment of the present disclosure, the light-emitting element assembly ES may include the optical lens F disposed on the light-emitting element E along the optical axis direction of the light-emitting element E or the upper surface direction of the light-emitting element E. The optical lens F may include the optical lenses F1 to F4 of the first to fourth groups disposed on the light-emitting elements E1 to E4 of the first to fourth groups, respectively. For example, the optical lens F1 of the first group may shape light emitted from the light-emitting element E1 of the first group into light whose light intensity is dispersed over a relatively wide spot size (e.g., the widest spot size among the optical lenses of the first to fourth groups) or a relatively wide spot size and light limited to the nearest visual field. The optical lens F4 of the fourth group may shape light emitted from the light-emitting element E4 of the fourth group into light whose light intensity is confined over a relatively narrow spot size (e.g., the narrowest spot size among the optical lenses of the first to fourth groups) or a relatively narrow spot size and light into expanded to the farthest visual field. The optical lenses F2 and F3 of the second and third groups may shape lights emitted from the light-emitting elements E2 and E3 of the second and third groups into lights having a narrower spot size than in the optical lens F1 of the first group and a wider spot size than in the optical lens F4 of the fourth group. More specifically, the optical lens F2 of the second group may shape the light emitted from the light-emitting elements E2 of the second group into light having a relatively wider spot size closer to the spot size of the optical lens F1 of the first group than the spot size of the optical lens F4 of the fourth group. The optical lens F3 of the third group may shape the light emitted from the light-emitting elements E3 of the third group into light having a relatively narrower spot size closer to the spot size of the optical lens F4 of the fourth group than the spot size of the optical lens F1 of the first group.

In an embodiment of the present disclosure, the spot size of the optical lens F2 of the second group may be formed wider than the spot size of the optical lens F3 of the third group, and the visual field of the optical lens F2 of the second group may be formed shorter than the visual field of the optical lens F3 of the third group.

In an embodiment of the present disclosure, the optical lenses F1 to F4 of the first to fourth groups may have spot sizes gradually reduced from the optical lens F1 of the first group to the optical lens F4 of the fourth group and may be confined to spot sizes with reduced light intensity, thereby maintaining sufficient light intensity even at a longer distance. Accordingly, a near visual field from a far visual field may be gradually provided from the optical lens F1 of the first group to the optical lens F4 of the fourth group. For example, the optical lenses F1 to F4 of the first to fourth groups may be formed so that the curvature or refractive power gradually increases from the optical lens F1 of the first group to the optical lens F4 of the fourth group.

As illustrated in FIG. 16, the light-emitting element assemblies ES1 to ES4 of the first to fourth groups may more easily maintain sufficient light intensity at a far distance from the light-emitting element assembly ES1 of the first group to the light-emitting element assembly ES4 of the fourth group, and gradually provide from a near visual field to a far visual field.

As illustrated in FIGS. 17A-17C, in order for light emitted from the light-emitting element assembly ES to be reflected with sufficient light intensity from a surrounding object B placed at a far distance and sensed with high sensitivity by the light receiving unit DU, the light-emitting element assembly ES may operate in a manner of increasing the light intensity as in FIG. 17B while having the same spot size as in FIG. 17A. In contrast, the light-emitting element assembly ES may have the same light intensity as in FIG. 17A, and may allow reflected light reflected from a distant surrounding object B to be reflected by reducing the spot size, thereby sensing the light with high sensitivity by using the light receiving unit DU. For example, in an embodiment of the present disclosure, the fact that a far visual field is gradually provided from the light-emitting element assembly ES1 of the first group to the light-emitting element assembly ES4 of the fourth group is because the optical lenses F1 to F4 of the first to fourth groups are configured to have a gradually higher curvature or a gradually higher refractive power so as to confine the same light intensity into a relatively narrow spot size, as in FIG. 17C.

Referring to FIGS. 18A and 18B, as in FIG. 18A, light with a relatively wide spot size forms a light intensity of relatively low reflected light from a surrounding object B at the same distance as the light intensity is dispersed to a wide spot size. On the other hand, as in FIG. 18B, light with a relatively narrow spot size forms a light intensity of relatively high reflected light from a surrounding object B at the same distance as the light intensity is confined to a narrow spot size. The light shape illustrated in FIG. 18B may provide relatively higher sensitivity than the light shape illustrated in FIG. 18A.

For example, as illustrated in FIGS. 17A to 18B, when it is necessary to increase the light intensity of reflected light or increase the sensitivity in order to recognize an object, it may be advantageous to emit light with a narrow spot size, and to this end, it may be advantageous to increase the curvature or refractive power of the optical lens F.

In an embodiment of the present disclosure, while simultaneously applying the optical lenses F1 to F4 of the first to fourth groups having different optical characteristics, the light-emitting element assembly ES1 of the first group to which the first group of optical lenses F1 are applied may be selectively operated to provide a close visual field for a near distance around the TOF sensor TOF (for example, by using the wide radiation angles of the light-emitting element assemblies ES1 of the first groups adjacent to each other, external objects are densely sensed over visual fields overlapping without gaps with spot sizes overlapping each other). The light-emitting element assembly ES4 of the fourth group to which the optical lens F4 of the fourth group is selectively applied may be operated to provide a visual field for a far distance around the TOF sensor TOF, and the light-emitting element assembly ES2 of the second group or the light-emitting element assembly ES3 of the third group may be selectively operated to provide a visual field for an intermediate distance around the TOF sensor TOF.

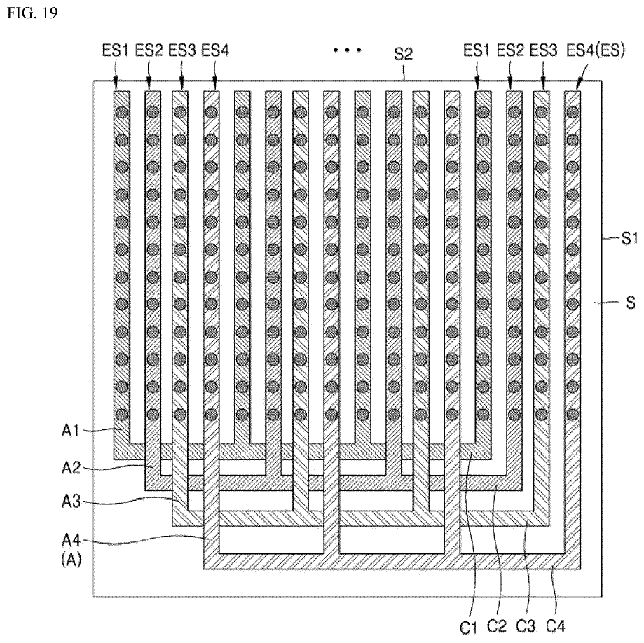

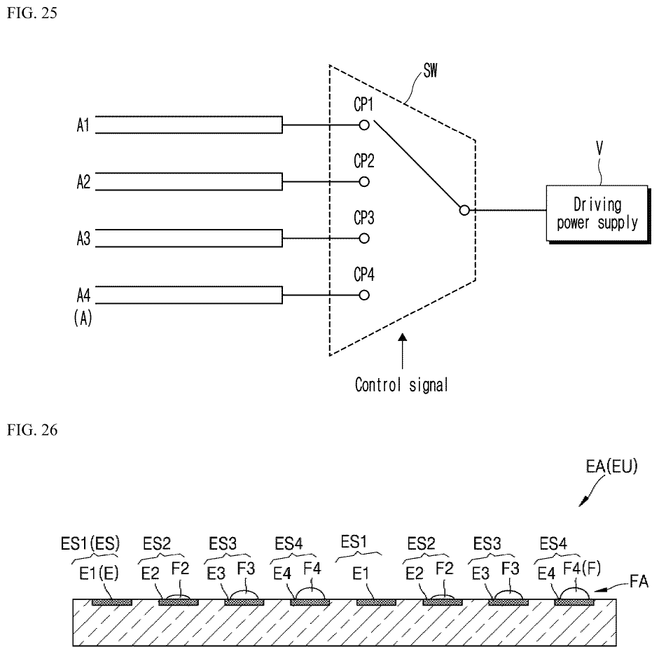

FIGS. 19 to 24 are views for explaining address structures of light-emitting units EU having different address structures for independently applying a driving voltage V to each of the light-emitting element assemblies ES1 to ES4 of the first to fourth groups. FIG. 25 is a view for explaining an embodiment for implementing a switching operation by interposing a switch between a driving power source V and first to fourth contact points CP1 to CP4 connected to address lines A1 to A4 of the first to fourth groups.

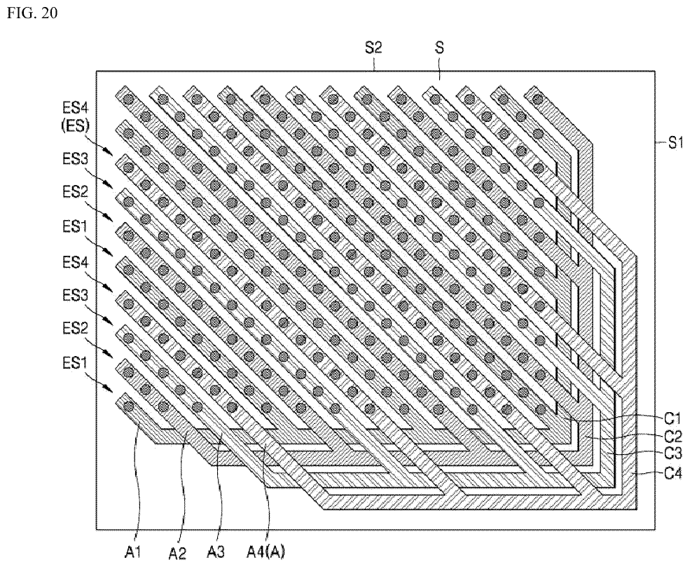

Referring to FIGS. 19 and 20, in an embodiment of the present disclosure, optical characteristics of the optical lenses F1 to F4 of the first to fourth groups or optical characteristics of the light-emitting element assemblies ES1 to ES4 of the first to fourth groups may be gradually changed, and the light-emitting element assemblies ES1 to ES4 of the first to fourth groups whose optical characteristics are gradually changed may be sequentially arranged along the transverse direction of the base substrate S. As described below, the light-emitting element assemblies ES1 to ES4 of the first to fourth groups may be separately connected to the address lines A1 to A4 of the first to fourth groups for applying the driving voltage V, respectively. For example, a switching operation may be performed to sequentially connect the address lines A1 to A4 of the first to fourth groups and the driving power source V so that the light-emitting unit EU or the TOF sensor TOF including the light-emitting unit EU may sequentially change a spot size and a viewing distance over time. In addition, the address lines A1 to A4 of the first to fourth groups or the light-emitting element assemblies ES1 to ES4 of the first to fourth groups connected to the address lines A1 to A4 of these first to fourth groups may be sequentially arranged so that a switching operation may be sequentially performed among the address lines A1 to A4 of different first to fourth groups.

As illustrated in FIGS. 19 and 20, in an embodiment of the present disclosure, the light-emitting elements E1 to E4 of the first to fourth groups may be arranged cyclically and alternately in the transverse direction along the base substrate S, and as described below, the address lines A1 to A4 of the first to fourth groups connected to the light-emitting elements E1 to E4 of the first to fourth groups may also be arranged cyclically and alternately in the transverse direction along the base substrate S. That is, the light-emitting elements E1 to E4 of the first to fourth groups may be arranged cyclically and alternately in the order of the light-emitting element E1 of the first group-the light-emitting element E2 of the second group-the light-emitting element E3 of the third group-the light-emitting element E4 of the fourth group-the light-emitting element E1 of the first group along the base substrate S. Similarly, the address lines A1 to A4 of the first to fourth groups may also be arranged cyclically and alternately in the order of the address line A1 of the first group-the address line A2 of the second group-the address line A3 of the third group-the address line A4 of the fourth group-the address line A1 of the first group. For example, in an embodiment of the present disclosure, the optical lenses F1 to F4 of the first to fourth groups may be formed so that a curvature or a refractive power gradually increases from the optical lens F1 of the first group to the optical lens F4 of the fourth group. For example, the optical lens F1 of the first group may shape light emitted from the light-emitting element E1 of the first group at a large radiation angle into light having a relatively large radiation angle and a wide spot size (light having the widest spot size) while refracting the light with a relatively low refractive power, and the optical lens F4 of the fourth group may shape light emitted from the light-emitting element E4 of the fourth group at a large radiation angle into light having a relatively small radiation angle and a narrow spot size (light having the narrowest spot size) while refracting the light with a relatively high refractive power.

In an embodiment of the present disclosure, the optical lenses F1 to F4 of the first to fourth groups may serve as condensing lenses that condense, around the optical axis, lights emitted in a form divergent from the light-emitting elements E1 to E4 of the first to fourth groups. In another embodiment of the present disclosure, in order to differentiate the form of lights emitted from the light-emitting elements E1 to E4 of the first to fourth groups, the optical lens F may not be disposed on any one of the light-emitting elements E1 to E4 of the first to fourth groups.

The light-emitting element assemblies ES1 to ES4 of the first to fourth groups, whose optical characteristics are gradually changed, may be sequentially arranged along the transverse direction of the base substrate S. As described below, the light-emitting element assemblies ES1 to ES4 of the first to fourth groups may be separately connected to the address lines A1 to A4 of the first to fourth groups for applying the driving voltage V. For example, a switching operation may be performed to sequentially connect the address lines A1 to A4 of the first to fourth groups and the driving power source V so that the light-emitting unit EU or the TOF sensor TOF including the light-emitting unit EU may sequentially change a spot size and a viewing distance over time. The light-emitting element assemblies ES1 to ES4 of the first to fourth groups, or the light-emitting element assemblies ES1 to ES4 of the first to fourth groups connected to the address lines A1 to A4 of the first to fourth groups, may be sequentially arranged so that switching operations may be sequentially performed between the address lines A1 to A4 of different first to fourth groups.

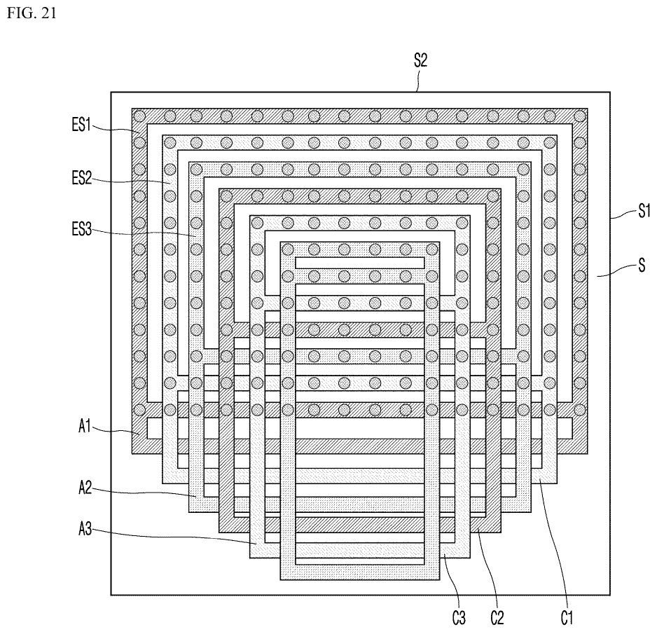

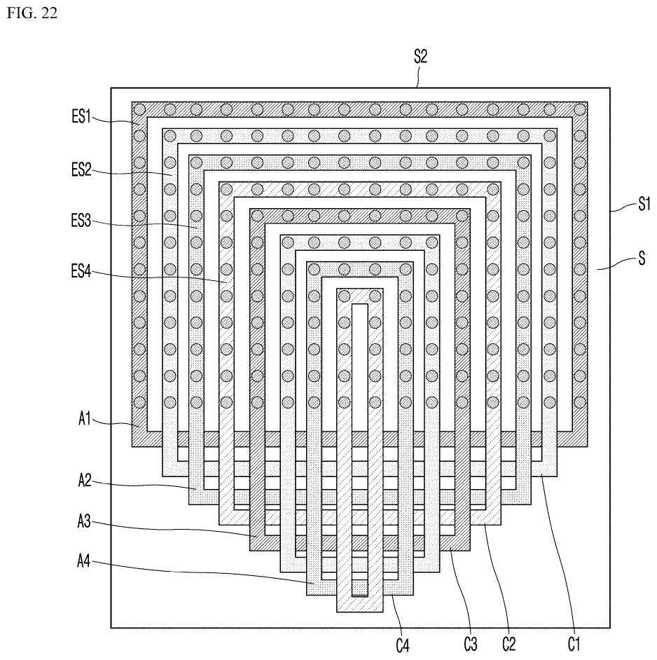

On the other hand, the light-emitting element assemblies ES1 to ES3 of the first to third groups or the light-emitting element assemblies ES1 to ES4 of the first to fourth groups are arranged sequentially as described above, and as illustrated in FIG. 21, each of the light-emitting element assembly ES1 to ES3 or ES1 to ES4 may include all of the characteristics described above, and may be arranged in a square shape. Alternatively, the light-emitting element assemblies ES1 to ES3 or ES1 to ES4 may be sequentially arranged, and may be arranged in a square shape with one side open, rather than a square shape, as illustrated in FIG. 22.

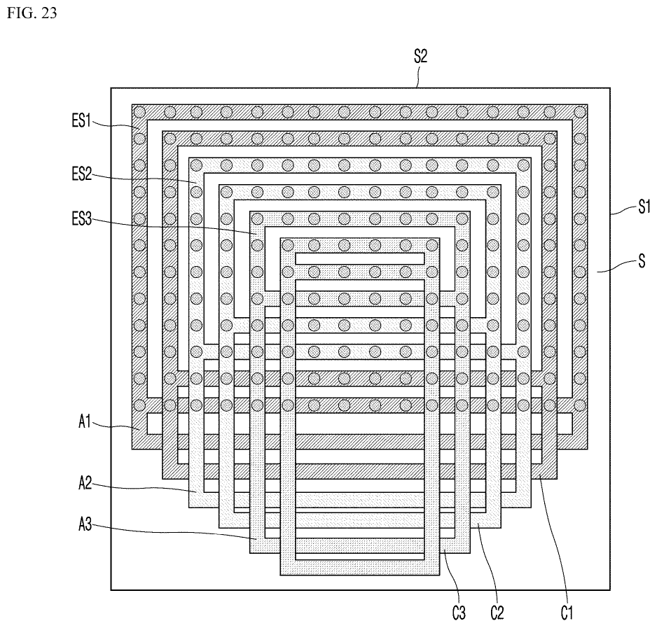

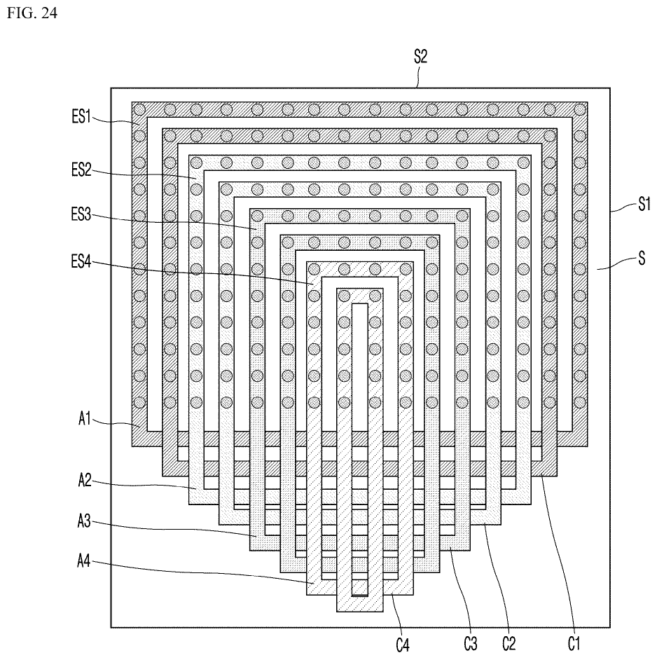

On the other hand, the light-emitting element assemblies ES1 to ES3 of the first to third groups or the light-emitting element assemblies ES1 to ES4 of the first to fourth groups may include all of the above-described characteristics, and may be arranged as illustrated in FIG. 23 or FIG. 24. As illustrated in FIG. 23, the light-emitting element assemblies ES1 of the first group may be arranged in a square shape on the outermost position or an inner side immediately adjacent to the outermost position, the light-emitting element assemblies ES2 of the second group may be arranged in a square shape inside the light-emitting element assemblies ES1 of the first group, and the light-emitting element assemblies ES3 of the third group may be arranged in the same shape inside the light-emitting element assemblies ES2 of the second group. Although FIG. 25 illustrates an example in which three groups are arranged, the present disclosure is not necessarily limited thereto and the number of light-emitting element assembly groups arranged may vary depending on the case.

In such a case, in the light-emitting element assembly ES1 of the first group arranged at the relatively outermost position, light-emitting elements that need to emit light with the highest output such as emitting light to the farthest distance, are arranged and are inwardly arranged in order of relatively decreasing output. Relatively large amounts of heat are inevitably generated from light-emitting elements that emit light with relatively high output. When such light-emitting elements are arranged in the center of the base substrate S, they may have an adverse influence on other adjacent light-emitting elements or light-emitting element assemblies (outwardly) during the heat dissipation process, and may cause problems in that heat dissipation is not smoothly performed, much time is required to dissipate heat, and a heat dome is formed inside. In order to solve such problems, the light-emitting element assembly ES1 of the first group is arranged at the relatively outermost position. Accordingly, heat generated during the operation of a corresponding assembly may be smoothly dissipated to the outside, and an influence on other assemblies during the dissipation process may be minimized. In addition, considering the speed at which heat is dissipated and the positional relationship of the assembly, the occurrence of a heat dome phenomenon that heat is not smoothly dissipated and remains, especially, a heat dome phenomenon occurring in the center, may be minimized. The light-emitting element assemblies of respective groups may be connected to the address lines A1 to A4 and the like as described above with reference to FIG. 19 and the like.

On the other hand, as illustrated in FIG. 24, the light-emitting element assemblies ES1 to ES4 of the first to fourth groups are arranged in the same manner as illustrated in FIG. 23 in which light-emitting element assemblies that need to emit light with the highest output are arranged at the outermost position, but may be arranged in a square shape with one side open instead of a square shape. Accordingly, the light-emitting element assemblies ES1 to ES4 of respective groups may be connected to the address lines A1 to A4 and the like more easily and in a simplified circuit manner.

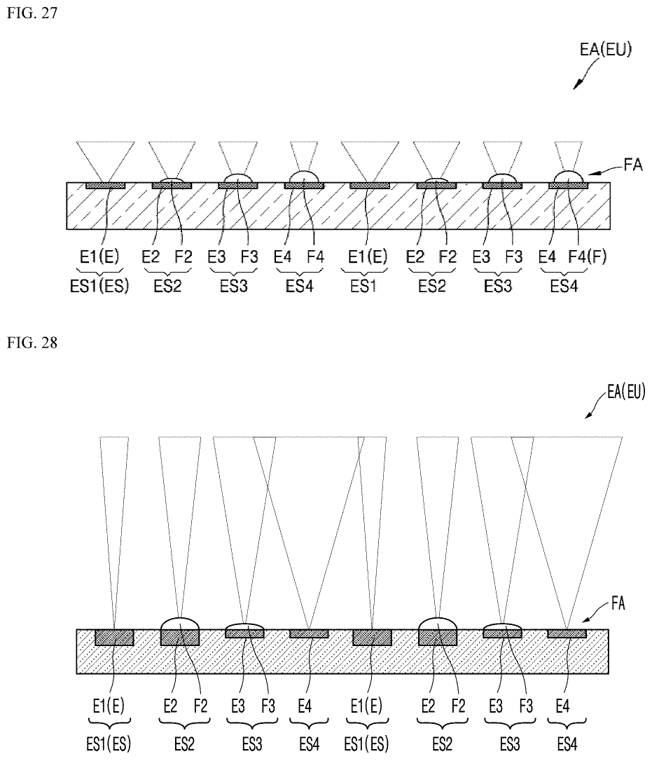

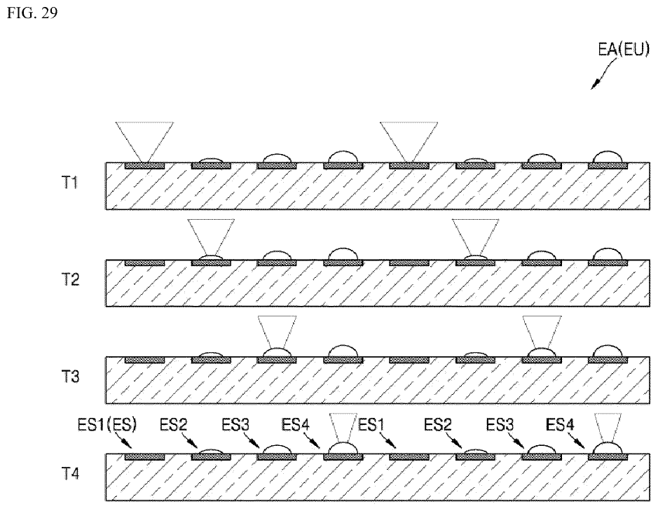

FIG. 26 is a view illustrating the cross-sectional structure of a light-emitting unit EU including an optical lens array FA arranged on a light-emitting element array EA in another embodiment of the present disclosure. FIG. 27 is a view exemplarily illustrating the forms of lights emitted from the light-emitting unit EU illustrated in FIG. 26 and providing different spot sizes (different radiation angles) and visual fields. FIG. 28 is a view exemplarily illustrating different forms of lights emitted from the light-emitting unit EU illustrated in FIG. 26. FIG. 29 is a view exemplarily illustrating a form in which lights providing different spot sizes (different radiation angles) and visual fields are sequentially output in a phase in which a light-emitting element assembly ES1 of a first group to a light-emitting element assembly ES4 of a fourth group in the light-emitting unit EU illustrated in FIG. 26 are sequentially driven, for example, at different times T1 to T4.

Referring to FIGS. 26 to 29, in another embodiment of the present disclosure, no optical lens F may be arranged on the light-emitting element E1 of the first group to shape light in a form in which a light intensity is dispersed over a wide range with a relatively wide spot size (light with the widest spot size). That is, since an optical lens F that condenses light emitted from the light-emitting element E1 of the first group is not arranged on the light-emitting element E1 of the first group, light with a relatively wide spot size may be emitted compared to the light-emitting element assemblies ES2 to ES4 of the second to fourth groups in which an optical lens F basically serving as a condensing lens is disposed. In this way, no optical lens F may be arranged on the light-emitting element E1 of the first group, and optical lenses F2 to F4 of second to fourth groups may be disposed on the light-emitting elements E2 to E4 of the second to fourth groups, and the optical lenses F2 to F4 of the second to fourth groups may be formed in a form in which a curvature or a refractive power gradually increases.

The fact that the light-emitting element assemblies ES1 to ES4 of the first to fourth groups provide light with a gradually changing spot size through the present specification does not limitedly mean that the optical lenses F1 to F4 of the first to fourth groups are respectively disposed on the light-emitting elements E of the light-emitting elements E1 to E4 of the first to fourth groups, but rather may encompass a structure in which no optical lens F is disposed on any one light-emitting element E among the light-emitting elements E1 to E4 of the first to fourth groups. For example, among the light-emitting elements E1 to E4 of the first to fourth groups, no optical lens F may be disposed on the first light-emitting element E that provides light with the widest spot size, and the light-emitting element assemblies ES1 to ES4 of the first to fourth groups may provide lights with gradually changing spot sizes. For example, the light-emitting element assembly ES1 of the first group may not include the optical lens F1 of the first group, and the light-emitting element E1 of the first group or the light-emitting element assembly ES1 of the first group may be formed with substantially the same structure in a broad sense. As described below, in various embodiments of the present disclosure, the optical lens F disposed on the light-emitting element E may include first and second condensing lenses L1 and L2 disposed in an overlapping manner relative to each other so that optical interference is possible. Even in such an embodiment, the optical lens F1 of the first group including the first and second condensing lenses L1 and L2 overlappingly disposed may not be disposed on the light-emitting element E1 of the first group, similar to the fact that the optical lens F1 of the first group is not disposed on the light-emitting element E1 of the first group. For example, even though the first and second condensing lenses L1 and L2 disposed in an overlapping manner relative to each other so that optical interference is possible are disposed on the light-emitting elements E2 to E4 of the second to fourth group, the first and second condensing lenses L1 and L2 overlappingly disposed may not be disposed on the light-emitting element E1 of the first group.

In an embodiment of the present disclosure, the optical lenses F1 to F4 of the first to fourth groups (when the optical lens F1 of the first group is excluded, the optical lenses F2 to F4 of the second to fourth groups, the same applies below) having a gradually increasing curvature or refractive power may be disposed on the light-emitting elements E1 to E4 of the first to fourth groups. In such a case, the optical lenses F1 to F4 of the first to fourth groups may be disposed on the upper surfaces of the light-emitting elements E1 to E4 of the first to fourth groups, and for example, the optical lenses F1 to F4 of the first to fourth groups may be supported on the light-emitting elements E1 to E4 of the first to fourth groups.

On the other hand, as illustrated in FIG. 27, in order to vary the spot sizes of lights output by the light-emitting element assemblies ES1 to ES4 of the first to fourth groups or the light-emitting elements E1 to E4 of the first to fourth groups included therein, not only whether the optical lens F1 to F4 are included or the type of the optical lens F1 to F4 is different, but also the radiation angle of the light-emitting elements E1 to E4 themselves may be additionally adjusted. For example, regardless of the face that a light-emitting element assembly (illustrated as ES1 or ES2 in FIG. 27) that needs to emit light to a far distance and thus output light having a relatively narrow radiation angle is adjusted using an optical lens, the light-emitting element (illustrated as E1 or E2 in FIG. 27) itself may emit light with a relatively narrow radiation angle. In contrast, a light-emitting element assembly (illustrated as ES3 or ES4 in FIG. 27) that needs to emit light to a near distance and thus output light having a relatively wide radiation angle may emit light to have a relatively wide radiation angle. Accordingly, the light-emitting element assemblies ES1 to ES4 of the first to fourth groups may adjust the radiation angle of light output more precisely by adjusting the radiation angles of the light-emitting element E1 to E4 themselves and the curvature or refractive power of the optical lens F1 to F4 disposed on the light path.

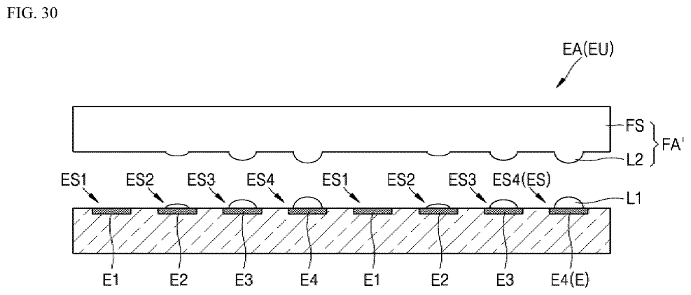

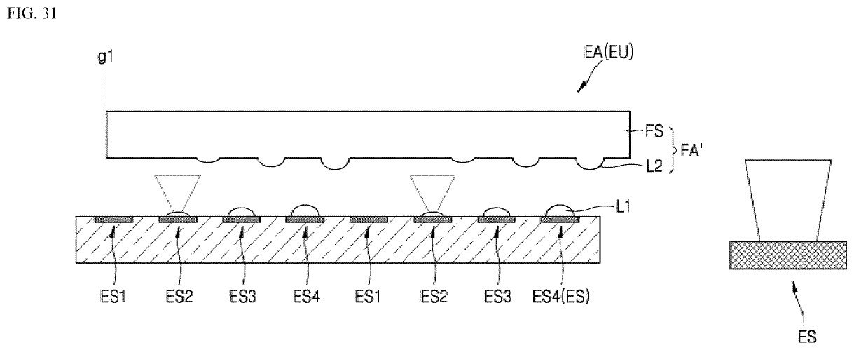

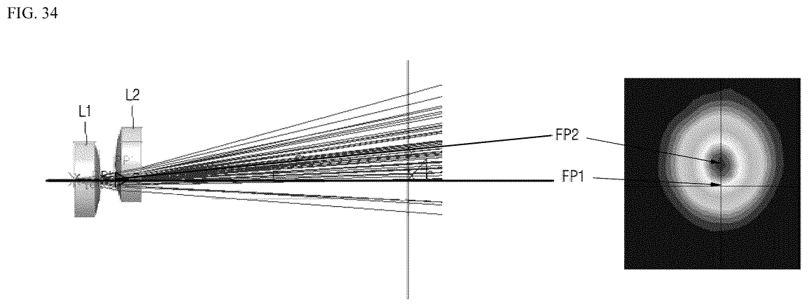

FIG. 30 is a view illustrating the cross-sectional structure of a light-emitting unit EU including an overlapping arrangement of a first condensing lens L1 supported on a light-emitting element E and a second condensing lens L2 spaced apart from the light-emitting element E in another embodiment of the present disclosure. FIGS. 31 to 33 are views exemplarily illustrating different forms of lights provided from the light-emitting unit EU according to different first to third positions g1 to g3 of the second condensing lens L2 with respect to the first condensing lens L1 in the light-emitting unit EU illustrated in FIG. 30. FIGS. 34 to 37 are views illustrating the forms of lights deflected at different degrees from the center of the first condensing lens L1 toward the center of the second condensing lens L2 through different curvatures or refractive powers or different optical arrangements of the first and second condensing lenses L1 and L2 in the light-emitting unit EU illustrated in FIG. 30.

Referring to FIGS. 30 to 37, in an embodiment of the present disclosure, the optical lenses F1 to F4 of the first to fourth groups (when the optical lens F1 of the first group is excluded, the optical lenses F2 to F4 of the second to fourth groups) may include first and second condensing lenses L1 and L2 disposed in an overlapping manner relative to each other so that optical interference is possible. Before describing such an embodiment in detail, a modified embodiment of the present disclosure is described with reference to the drawings above.

That is, in the modified embodiment of the present disclosure, the optical lenses F1 to F4 of the first to fourth groups may be arranged on the optical axes of the light-emitting elements E1 to E4 of the first to fourth groups even though they are not supported on the light-emitting elements E1 to E4 of the first to fourth groups. For example, the optical lenses F1 to F4 of the first to fourth groups may exhibit appropriate refractive power for lights emitted from the light-emitting elements E1 to E4 of the first to fourth groups on the optical axes of the light-emitting elements E1 to E4, and the optical lenses F1 to F4 of the first to fourth groups (when the optical lens F1 of the first group is excluded, the optical lenses F2 to F4 of the second to fourth groups) may be disposed on the optical axes of respective light-emitting elements E and supported at a height spaced from the light-emitting elements E by an appropriate support structure. In various embodiments of the present disclosure, the optical lenses F1 to F4 of the first to fourth groups may be provided as an integral optical lens array FA integrally connected to one another, and the integral optical lens array FA may be made of an optically transparent optical material. For example, as illustrated in FIG. 31, the integrated optical lens array FA may include a flat support FS and the optical lenses F1 to F4 of the first to fourth groups (when the optical lens F1 of the first group is excluded, the optical lenses F2 to F4 of the second to fourth groups) formed at positions corresponding to the optical axes of the light-emitting elements E1 to E4 of the first to fourth groups on the lower surface of the support FS facing the light-emitting elements E1 to E4 of the first to fourth groups. In an embodiment of the present disclosure, the optical lenses F2 to F4 of the second to fourth groups may be formed in a form in which the optical lens F1 of group 1 is excluded, and may be formed in a form of being connected to one another by the support FS. The optical lens F1 of the first group may be formed in a flat shape having a curvature of substantially zero, and the optical lenses F2 to F4 of the second to fourth groups may be formed in a shape having a curvature that gradually increases.

As illustrated in FIG. 30, in an embodiment of the present disclosure, each of the optical lenses F1 to F4 of the first to fourth groups (when the optical lens F1 of the first group is excluded, the optical lenses F2 to F4 of the second to fourth groups, respectively) may be disposed in an overlapping manner so that optical interference is possible relative to each other, and may include first and second condensing lenses L1 and L2 disposed at different heights along the optical axes of the light-emitting elements E1 to E4 of the first to fourth groups. For example, light emitted in a form divergent from the light-emitting element E may be condensed around the optical axis through the first condensing lens L1 and its spot size may be reduced, and the spot size may be further reduced as the light is condensed once more around the optical axis through the second condensing lens L2 arranged following the first condensing lens L1. That is, in an embodiment of the present disclosure, the spot size may be reduced in a chain manner while passing through the first and second condensing lenses L1 and L2, which are formed at different heights along the optical axis, in an overlapping manner. For example, in an embodiment in which only one condensing lens is formed out of the first condensing lens L1 supported on the light-emitting element E and the second condensing lens L2 (the second condensing lens L2 formed in the form of the integrated optical lens array FA) supported at a height spaced from the light-emitting element E, a visual field extended to a far distance may be provided with a relatively reduced spot size. According to the overlapping arrangement of the first and second condensing lenses L1 and L2, a more far visual field may be provided around the TOF sensor TOF, and the TOF sensor TOF may sense the position of a surrounding object B disposed at a more distant position by the first and second condensing lenses L1 and L2 providing the far visual field.

Referring to FIGS. 31 to 33, in an embodiment of the present disclosure, the first and second condensing lenses L1 and L2 may be aligned so that the optical axes of the first and second condensing lenses L1 and L2 coincide with the optical axis of the light-emitting element E. In this way, light of a form in which an optical axis position FP having the highest light intensity does not change may be provided by the first and second condensing lenses L1 and L2 disposed on the optical axes that coincide with each other (for example, a second position of the second condensing lens L2). For example, the optical axis position FP2 of light sequentially passing through the first and second condensing lenses L1 and L2 may coincide with the optical axis position FP1 of light passing through only the first condensing lens L1 or the optical axis position FP of the light-emitting element E.

In various embodiments of the present disclosure, the first and second condensing lenses L1 and L2 may be condensing so that their optical axes are offset from each other (for example, the third position g3 of the second condensing lens L2). By disposing the first and second condensing lenses L1 and L2 whose optical axes are offset from each other, it is possible to provide a deflected light in which the optical axis position FP2 having the highest light intensity is changed differently from the optical axis position of the light-emitting element E or the optical axis position FP1 of the first condensing lens L1 supported on the light-emitting element E. For example, in an embodiment of the present disclosure, the optical axes of the light-emitting element E and the first condensing lens L1 may be aligned with each other (the second position g2 of the second condensing lens L2), and the optical axes of the first and second condensing lenses L1 and L2 may be offset from each other (the third position of the second condensing lens L2). In such an embodiment, light whose optical axis positions FP1 and FP2 are not changed may be provided by the first and second condensing lenses L1 and L2 whose optical axes are aligned with each other (the second position g2 of the second condensing lens L2), or deflected light whose optical axis positions FP1 and FP2 are changed (for example, light whose optical axis position FP2 is deflected toward the center of the second condensing lens L2 while passing through the second condensing lens L2) may be provided by the first and second condensing lenses L1 and L2 whose optical axes are offset from each other. More specifically, the optical axis of light emitted from the first condensing lens L1 may be deflected toward the center of the second condensing lens L2 while passing through the second condensing lens L2, and light, in which the optical axis position FP2 of light emitted from the second condensing lens L2 is deflected toward the center of the second condensing lens L2 while passing through the second condensing lens L2 with the optical axis of the light-emitting element E or the optical axis of the first condensing lens L1 as the center, may be provided.

For example, in an embodiment in which the first and second condensing lenses L1 and L2 are disposed to be offset from each other to provide light that is deflected with respect to the optical axis of the light-emitting element E or the optical axis of the first condensing lens L1 supported on the light-emitting element E (the third position g3 of the second condensing lens L2), the centers or optical centers (optical axis positions FP1 and FP2) of the first and second condensing lenses L1 and L2 may be spaced apart from each other along the upper surface of the light-emitting element E or along a direction intersecting the optical axis. The centers or optical centers (optical axis positions FP1 and FP2) of the first and second condensing lenses L1 and L2 may have an arrangement in which they are spaced apart from each other but overlap each other at least partially. According to such an arrangement in which the first and second condensing lenses L1 and L2 are offset from each other (for example, the third position g3 of the second condensing lens L2), each condensing lens may form optical interference with each other. By the overlapping arrangement of the first and second condensing lenses L1 and L2 each serving as a condensing lens, each condensing lens may provide a relatively far visual field while providing light that is deflected toward the center of the second condensing lens L2.

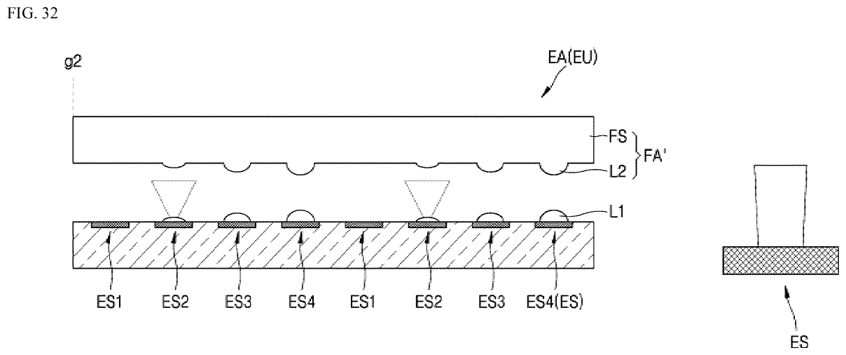

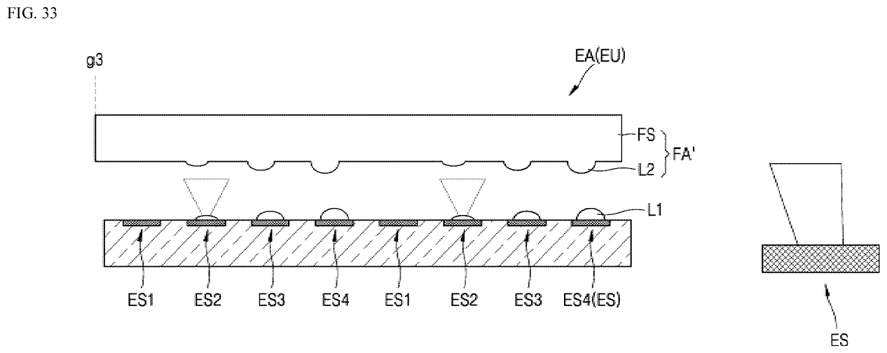

In an embodiment of the present disclosure, the second condensing lens L2 or the optical lens array FA (for example, an integral optical lens array FA in which a plurality of second condensing lenses L2 are integrally connected to one another) in which the second condensing lens L2 is arranged may be supported to enable translational motion along a direction parallel to the upper surface of the light-emitting element E from which light is emitted. By the translational motion of the optical lens array FA, the optical lens array FA may move the second condensing lens L2 among the first to third positions g1 to g3 different from one another. Accordingly, the optical lens array FA may change the characteristics of light emitted from the light-emitting element E or the TOF sensor TOF including the light-emitting element E. For example, as illustrated in FIG. 31, by the translational motion of the optical lens array FA between the first to third positions g1 to g3, the TOF sensor TOF may provide light with a relatively wide spot size by using the first condensing lens L1 at the first position g1 where the second condensing lens L2 is completely out of the first condensing lens L1. In addition, as illustrated in FIG. 32, at the second position g2 where the second condensing lens L2 coincides with the optical axis of the first condensing lens L1, that is, at the second position g2 where the optical axes of the first and second condensing lenses L1 and L2 are aligned with each other, the TOF sensor TOF may provide light with a reduced spot size and a more extended far visual field than at the first position g1. As illustrated in FIG. 33, at the third position g3 where the second condensing lens L2 is offset from the optical axis of the first condensing lens L1, that is, at the third position g3 where the optical axes of the first and second condensing lenses L1 and L2 are offset from each other, the TOF sensor TOF may provide light that is deflected toward the center of the second condensing lens L2 more than at the second position g2. In this way, the TOF sensor TOF may provide different types of lights by the second condensing lens L2 supported to enable translation motion between the first to third positions g1 to g3 different from one another along the direction parallel to the upper surface of the light-emitting element E from which light is emitted, or the optical lens array FA in which the second condensing lens L2 is arranged.

In an embodiment of the present disclosure, no optical lens F may be disposed on the first light-emitting element E that provides the widest spot size, and for example, the first and second condensing lenses L1 and L2 may not be disposed on the first light-emitting element E. In such an embodiment, as illustrated in FIGS. 31 to 33, even though the second condensing lens L2 or the optical lens array FA, in which the second condensing lens L2 is arranged, is translated among the first position to the third position g1 to g3, the second condensing lens L2 may not be disposed on the first light-emitting element E as well as the first condensing lens L1. However, in various embodiments of the present disclosure, the second condensing lens L2 may not be disposed on the first light-emitting element E at the first position g1, but the second condensing lens L2 may also be disposed on the first light-emitting element E at the second position g2 and the third position g3. In such an embodiment, the first and second condensing lenses L1 and L2 may be overlappingly disposed on the second to fourth light-emitting elements E2 to E4, but only the second condensing lens L2 may be disposed on the first light-emitting element E without the first condensing lens L1, thereby shaping light emitted from the first light-emitting element E into light with a reduced spot size (visual field expanded to a far distance).

In an embodiment of the present disclosure, the optical axes of the first and second condensing lenses L1 and L2 are offset from each other (the third position g3 of the second condensing lens L2), and the optical axis position FP of the first condensing lens L1 or the position where the light intensity of light passing through the first condensing lens L1 is the highest may be deflected toward the center of the second condensing lens L2. Accordingly, light emitted from the light-emitting element E or the TOF sensor TOF including the light-emitting element E may be deflected. The TOF sensor TOF according to an embodiment of the present disclosure may be mounted on a transport robot capable of driving in an autonomous driving mode, and in such a case, depending on the driving direction of the transport robot provided with the TOF sensor TOF and the mounting position of the TOF sensor TOF, it may be necessary to deflect the light emission direction from the TOF sensor TOF. For example, it may be necessary to deflect the light emission direction from the TOF sensor TOF at the time of changing the driving direction of the robot or prior to the direction changing time, and to detect the presence or absence of an obstacle, i.e., a surrounding object B, and the position of the surrounding object B.

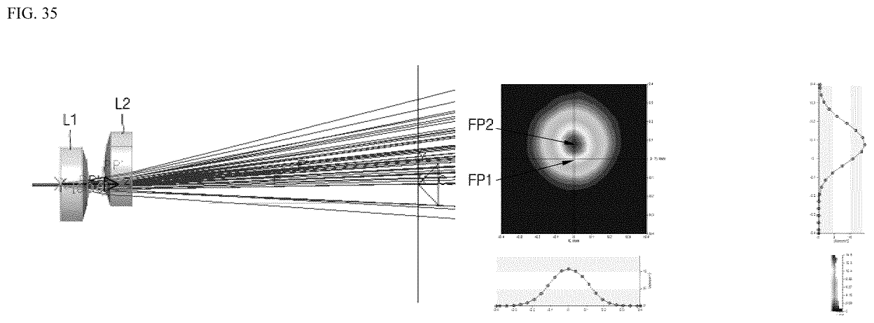

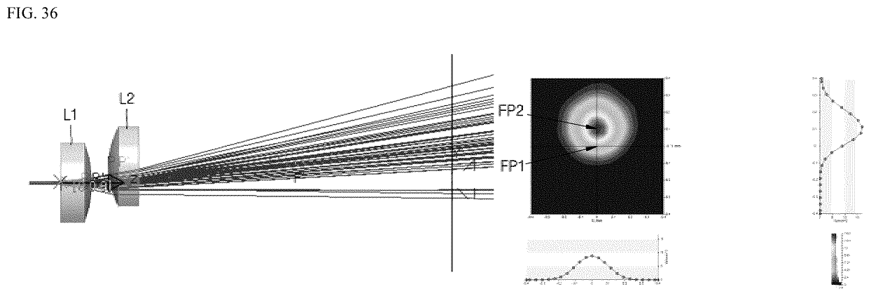

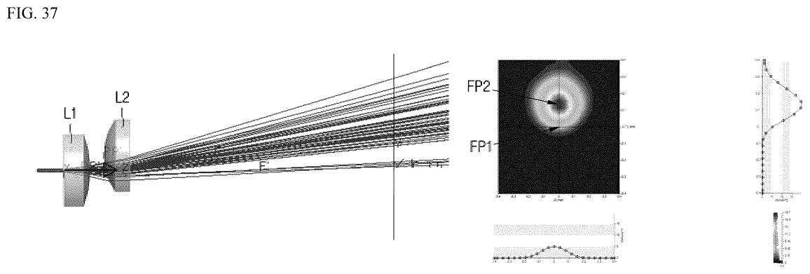

As illustrated in FIGS. 34 to 37, by using the arrangement in which the first and second condensing lenses L1 and L2 are offset from each other (the third position g3 of the second condensing lens L2), the optical axis of light passing through the first condensing lens L1 may be deflected toward the center of the second condensing lens L2, and the optical axis position FP or the position where the intensity of light is the highest may be captured at a position deflected from the optical axis position FP of the first condensing lens L1. For example, the degree of deflection of the optical axis position FP2 (optical axis position FP2 of light emitted from the second condensing lens L2) from the optical axis position FP1 of the first condensing lens L1 may vary depending on the specific design of the first and second condensing lenses L1 and L2 such as the degree to which the optical axes of the first and second condensing lenses L1 and L2 are spaced from each other or the curvature or refractive power of the first and second condensing lenses L1 and L2 (for example, a difference in the curvature or refractive power of the first and second condensing lenses L1, L2). For example, FIGS. 35 to 37 illustrate simulation results for measuring an angle, at which the optical axis position FP2 (the optical axis position with the highest light intensity) of light passing through the first and second condensing lenses L1 and L2 is deflected from the optical axis position FP1 of the first condensing lens L1 toward the center of the second condensing lens L2, when the centers of the first and second condensing lenses L1 and L2 are disposed to be offset from each other by 50 μm or when the optical axes of the first and second condensing lenses L1 and L2 are disposed to be offset from each other by 50μm. In the simulation of FIG. 35, when the curvature of the first condensing lens L1 is 3 and the curvature of the second condensing lens L2 is 3, an angle at which the optical axis or optical axis position FP2 of the first and second condensing lenses L1 and L2 is deflected from the optical axis or optical axis position FP1 of the first condensing lens L1 is 5.1°. In the simulation of FIG. 36, when the curvature of the first condensing lens L1 is 3 and the curvature of the second condensing lens L2 is 4, an angle at which the optical axis or optical axis position FP2 of the first and second condensing lenses L1 and L2 is deflected from the optical axis or optical axis position FP1 of the first condensing lens L1 is 6.7°. In the simulation of FIG. 37, when the curvature of the first condensing lens L1 is 3 and the curvature of the second condensing lens L2 is 5, an angle at which the optical axis or optical axis position FP2 of the first and second condensing lenses L1 and L2 is deflected from the optical axis or optical axis position FP1 of the first condensing lens L1 was calculated to be 8.4°. According to such simulation results of FIGS. 35 to 37, an angle at which the optical axes are deflected may vary depending on the degree, to which the optical axes or centers of the first and second condensing lenses L1 and L2 are offset from each other (for example, 50μm by which the optical axes or centers of the first and second condensing lenses L1, L2 are offset from each other in FIGS. 35 to 37), the curvature of each of the first and second condensing lenses L1 and L2 (for example, the curvature of 3 to 5 in FIGS. 35 to 37), or the like.

Referring to FIGS. 19 to 26, the light-emitting unit EU according to an embodiment of the present disclosure may include the address line A for selectively turning ON/OFF any one of the light-emitting element assemblies ES1 to ES4 of the first to fourth groups, and for example, may include the address lines A1 to A4 of the first to fourth groups electrically connected to the light-emitting element assemblies ES1 to ES4 of the first to fourth groups, respectively, to individually or selectively provide driving lines to the light-emitting element assemblies ES1 to ES4 of the first to fourth groups. For example, in an embodiment of the present disclosure, the address lines A1 to A4 of the first to fourth groups may form power supply lines that connect the first electrode contact layers M1 of the light-emitting elements E1 to E4 of the first to fourth groups to each other. More specifically, the address line A1 of the first group may connect the first electrode contact layers M1 of the light-emitting elements E1 of the first group, the address line A2 of the second group may connect the first electrode contact layers M1 of the light-emitting elements E2 of the second group, the address line A3 of the third group may connect the first electrode contact layers M1 of the light-emitting elements E3 of the third group, and the address line A4 of the fourth group may connect the first electrode contact layers M1 of the light-emitting elements E4 of the fourth group.

In this way, the address lines A1 to A4 of the first to fourth groups may be connected to the first electrode contact layer M1 of the light-emitting elements E1 to E4 of the first to fourth groups, and the second electrode contact layer M2 of the light-emitting elements E1 to E4 of the first to fourth groups may be connected to a common ground line. In an embodiment of the present disclosure, the first electrode contact layer M1 of the light-emitting elements E1 to E4 of the first to fourth groups may be connected to the address lines A1 to A4 of the first to fourth groups electrically disconnected from one another, and unlike the first electrode contact layer M1 of the light-emitting elements E1 to E4 of the first to fourth groups, the second electrode contact layer M2 of the light-emitting elements E1 to E4 of the first to fourth groups may be connected to the common ground line and electrically connected to one another.

Referring to FIG. 25, in an embodiment of the present disclosure, the light-emitting elements E1 to E4 of the first to fourth groups or the light-emitting element assemblies ES1 to ES4 of the first to fourth groups may be selectively turned ON/OFF by using the address lines A1 to A4 of the first to fourth groups individually formed, that is, the address lines A1 to A4 of the first to fourth groups electrically disconnected from one another so that the driving voltage V is applied independently of one another. For example, a switch SW may be interposed between the driving power source V provided in the light-emitting unit EU and the address lines A1 to A4 of the first to fourth groups. In an embodiment of the present disclosure, the switch SW may be implemented as a 5-contact switch SW or a multiplexer that is interposed between the first to fourth contacts CP1 to CP4 connected to the address lines A1 to A4 of the first to fourth groups and the terminal of the driving power source V, and connects any one of the first to fourth contacts CP1 to CP4 and the driving power source V according to a control signal. Alternatively, the switch SW may be implemented as a four-stage selector switch that can be pivotally rotated along the first to fourth contacts CP1 to CP4 arranged along the circumference direction so that user settings from the outside are also possible. The switch SW may perform a switching operation of alternately connecting the first to fourth contacts CP1 to CP4 under the control of an operation processing unit (not illustrated) that applies a control signal according to user's settings or the driving state of the transport robot provided with the TOF sensor TOF. For example, the switch SW may connect the first contact CP1 to the address line A1 of the first group or the light-emitting element assembly ES1 of the first group in order to provide a near visual view when the transport robot is traveling at a relatively low speed, in accordance with the traveling speed of the transport robot, and may gradually transition a connection state from the second contact CP2 to the fourth contact CP4 toward the address line A4 of the fourth group or the light-emitting element assembly ES4 of the fourth group as the traveling speed increases. For example, the switch SW may connect the fourth contact CP4 to the address line A4 of the fourth group or the light-emitting element assembly ES4 of the fourth group in order to provide a far visual view when the transport robot provided with the TOF sensor TOF is traveling at a high speed.

For example, the transport robot may switch the switch SW to be connected to the first contact point CP1 in order to densely sense a near visual field (provide a close visual field without gaps with overlapping spot sizes by using the first contact point CP1 or the light-emitting element assembly ES1 of the first group connected to the address line A1 of the first group) while traveling at a low speed at a region with relatively dense surrounding objects B (region with many obstacles), and may switch the switch SW to be connected to the fourth contact point CP4 in order to sense a far visual field while traveling at a high speed at a region with relatively few surrounding objects B (region with few obstacles).

In various embodiments of the present disclosure, the address lines A1 to A4 of the first to fourth groups may extend in various forms. For example, in the embodiment illustrated in FIG. 19, the base substrate S may include first and second edges S1 and S2 intersecting with each other. In such a case, the light-emitting elements E1 to E4 of the first to fourth groups may be arranged along the direction of the first edge S1 of the base substrate S, and alternately disposed along the direction of the second edge S2. In addition, the address lines A1 to A4 of the first to fourth groups may extend in a parallel direction along the first edge S1 of the base substrate S, and may incorporate a plurality of light-emitting elements E arranged in parallel along the first edge S1 of the base substrate S into one group of light-emitting elements E belonging to the same group. For example, the light-emitting element assemblies ES1 to ES4 of the first to fourth groups may be arranged along the direction of the first edge S1 and alternately disposed in a circular manner along the direction of the second edge S2, and the address line A1 of the first group may extend along the direction of the first edge S1 and electrically connect the light-emitting element assembly ES1 of the first group and the first electrode contact layer M1 of the light-emitting element E1 of the first group arranged along the direction of the first edge S1. Similarly, the address lines A2 to A4 of the second to fourth groups may extend along the direction of the first edge S1 and electrically connect the light-emitting element assemblies ES2 to ES4 of the second to fourth groups and the first electrode contact layer M1 of the light-emitting elements E2 to E4 of the second to fourth groups arranged along the direction of the first edge S1.

In an embodiment of the present disclosure, the address lines A1 to A4 of the first to fourth groups may extend in parallel along the direction of the first edge S1, and the address lines A1 to A4 of the first to fourth groups may be arranged cyclically and alternately along the direction of the second edge S2. Connection lines C1 to C4 of first to fourth groups extending across the ends of the address lines A1 to A4 of the first to fourth groups while extending along the direction of the second edge S2 may be disposed to connect the address lines A1 to A4 of the first to fourth groups extending in parallel along the direction of the first edge S1.

In another embodiment of the present disclosure, as illustrated in FIG. 20, the base substrate S may include first and second edges S1 and S2 intersecting with each other, and the light-emitting elements E1 to E4 of the first to fourth groups may be arranged along a diagonal direction simultaneously following the directions of the first and second edges S1 and S2. The address lines A1 to A4 of the first to fourth groups may extend along the diagonal direction simultaneously following the directions of the first and second edges S1 and S2 of the base substrate S, and incorporate a plurality of light-emitting elements E arranged in parallel along the diagonal direction into one group of light-emitting elements E belonging to the same group. For example, the light-emitting element assemblies ES1 to ES4 of the first to fourth groups may be arranged along the diagonal direction simultaneously following the directions of the first and second edges S1 and S2 and may be disposed cyclically and alternately along a cross diagonal direction intersecting with the diagonal direction. The address line A1 of the first group may extend along the diagonal direction and electrically connect the light-emitting element assembly ES1 and the first electrode contact layer M1 of the light-emitting element E1 of the first group arranged along the diagonal direction. Similarly, the address lines A2 to A4 of the second to fourth groups may extend along the diagonal direction and electrically connect the light-emitting element assemblies ES2 to ES4 of the second to fourth groups and the first electrode contact layer M1 of the light-emitting elements E2 to E4 of the second to fourth groups arranged along the diagonal direction.

In an embodiment of the present disclosure, each of the address lines A1 to A4 of the first to fourth groups may include a plurality of address lines A1 to A4 of the first to fourth groups extending in parallel along the diagonal direction, and the plurality of address lines A1 to A4 of the first to fourth groups may be disposed cyclically and alternately along the cross diagonal direction intersecting with the diagonal direction. In an embodiment of the present disclosure, connection lines C1 to C4 of first to fourth groups extending across the ends of a plurality of address lines A1 to A4 of the first to fourth groups while extending in a bent shape along the direction of the second edge S2 may be disposed. The connection lines C1 to C4 of the first to fourth groups may connect the plurality of address lines A1 to A4 of the first to fourth groups, which extend in parallel along the diagonal direction, to one another.

In various embodiments of the present disclosure, the address lines A1 to A4 of the first to fourth groups and the connection lines C1 to C4 of the first to fourth groups may be disposed on the upper surface of the light-emitting element E in which the first electrode contact layer M1 is disposed or on the upper surface of the light-emitting element array EA in which a plurality of light-emitting elements E are arranged.

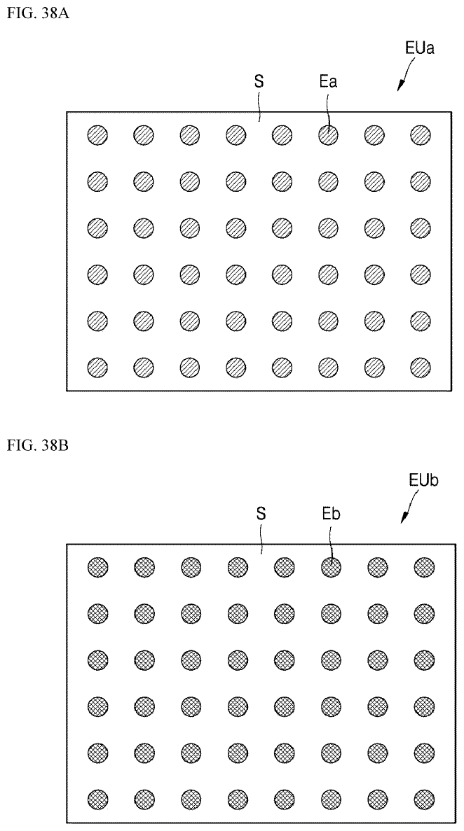

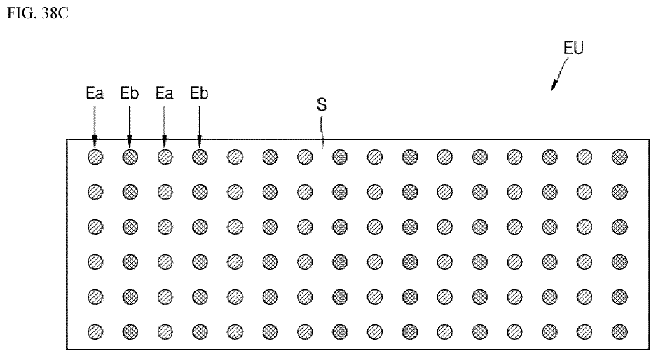

FIGS. 38A to 38C are views for explaining the technical effects of alleviating the deterioration of the light-emitting element E in the light-emitting element array EA or the light-emitting unit EU including the light-emitting element array EA according to an embodiment of the present disclosure.

Referring to FIGS. 38A to 38C, an embodiment of the present disclosure discloses a TOF sensor TOF that includes the light-emitting element array EA formed on one base substrate S and can provide light whose optical characteristics are adaptively and flexibly changed while being applied, by using the address lines A1 to A4 of the first to fourth groups for independently driving the light-emitting element assemblies ES1 to ES4 of the first to fourth groups, respectively, and a switch SW for connecting the address lines A1 to A4 of the first to fourth groups to the driving power source V and the power source. In particular, in an embodiment of the present disclosure, all the light-emitting elements E arranged on one base substrate S are not instantaneously turned on at the same time, and a switching operation is performed between the address lines A1 to A4 of the first to fourth groups and the driving power source V, so that one group of light-emitting elements E among the light-emitting elements E1 to E4 of the first to fourth groups are selectively turned on. Accordingly, the TOF sensor TOF is advantageous in heat dissipation, and the heat dissipation structure can be simplified compared to the number of the same light-emitting elements E.

Referring to FIGS. 38A and 38B, a comparative example compared with the present disclosure includes a base substrate S including a plurality of light-emitting elements Ea and Eb belonging to different groups and light-emitting units EUa and EUb including different base substrates S and separated from each other, in order to provide different spot sizes and different viewing distances. In such an embodiment, a heat generation problem may occur when the light-emitting elements Ea and Eb arranged adjacent to each other are turned on simultaneously, and for example, separate heat dissipation design may be required for each of the light-emitting unit EUa and EUb. Referring to FIG. 38C, in an embodiment of the present disclosure, different groups of light-emitting elements Ea and Eb (or different groups of light-emitting element assemblies) providing different types of lights are formed on one base substrate S, and one group of light-emitting elements Ea and Eb (or one group of light-emitting element assemblies) are not turned on simultaneously but are turned on selectively. Accordingly, in an embodiment of the present disclosure, a light-emitting unit EU selectively providing different types of lights can be provided in a more compact form, and convenience in the process can be ensured. In addition, in an embodiment of the present disclosure, heat can be quickly dissipated through a large area of base substrate S according to a switching operation that is alternately turned on at different times, and separate heat dissipation design may not be required.

In an embodiment of the present disclosure, by forming an ion implantation layer P on each light-emitting element E to block defect migration from a defect source to a central region of an active layer AR, a TOF sensor TOF including a light-emitting element array EA including a plurality of light-emitting elements E, a light-emitting unit EU including the light-emitting element array EA, and the light-emitting unit EU can prevent a recognition error of a surrounding object B due to deterioration of a light-emitting element E (for example, a recognition error of not recognizing a surrounding object B due to deterioration of a light-emitting element E, or the like). Even though a plurality of light-emitting elements E are arranged on one base substrate S, an appropriate amount of light emitted from each light-emitting element E is preferably maintained when considering the number of light-emitting elements E that are turned on instantaneously (only one group of light-emitting elements are selectively turned on among light-emitting elements E1 to E4 of first to fourth groups. In order to prevent deterioration of each light-emitting element E, blocking the defect migration from the defect source to the central region of the active layer AR may be preferable in an embodiment of the present disclosure.

An embodiment of the present disclosure discloses a light-emitting element unit EU including a plurality of light-emitting elements E including different light-emitting elements E1 to E4 of first to fourth groups, a plurality of optical lenses F including optical lenses F1 to F4 of the first to fourth groups respectively disposed on the light-emitting elements E1 to E4 of the first to fourth groups, and a plurality of address lines A including address lines A1 to A4 of the first to fourth groups electrically connected to the light-emitting elements E1 to E4 of the first to fourth groups, respectively, and electrically disconnected from one another.

In various embodiments of the present disclosure, a light-emitting element unit EU may include light-emitting elements E electrically connected to each other by different address lines A and optical lenses F disposed on the light-emitting elements E. One group of light-emitting elements E and another group of light-emitting elements E may be connected to one group of address lines A and another group of address lines A, respectively, and may be driven at different times. Various embodiments of the present disclosure include one group of light-emitting elements E and another group of light-emitting elements E that may be electrically connected to each other through one group of address lines A and another group of address lines A and may be switched on/off at different times. Various embodiments of the present disclosure include one group of optical lenses F and another group of optical lenses F disposed on one group of light-emitting elements E and another group of light-emitting elements E, in order to provide lights emitted from one group of light-emitting elements E and another group of light-emitting elements E with different spot sizes and different viewing distances.

The above description is merely a description of the technical spirit of the present embodiment, and those skilled in the art may change and modify the present embodiment in various ways without departing from the essential characteristic of the present embodiment. Accordingly, the embodiments should not be construed as limiting the technical spirit of the present embodiment, but should be construed as describing the technical spirit of the present embodiment. The technical spirit of the present embodiment is not restricted by the embodiments. The range of protection of the present embodiment should be construed based on the following claims, and all of technical spirits within an equivalent range of the present embodiment should be construed as being included in the scope of rights of the present embodiment.

What is claimed is:

1. A light-emitting unit comprising:
a base substrate;
a plurality of groups of light-emitting elements arranged on the base substrate and sequentially arranged in a preset shape at the outermost position and inside the outermost position; and
address lines electrically connected to the light-emitting elements of each group, respectively, and electrically disconnected from each other,
wherein some or all of the light-emitting elements have different radiation angles.

2. The light-emitting unit of claim 1, further comprising:
a plurality of groups of optical lenses disposed on the light-emitting elements of each group.

3. The light-emitting unit of claim 2, wherein some of the optical lenses are not disposed on the light-emitting elements.

4. The light-emitting unit of claim 2, wherein some or all of the optical lenses have different curvatures or refractive powers.

5. The light-emitting unit of claim 4, wherein some or all of the light-emitting elements have different spot sizes.

6. The light-emitting unit of claim 1, wherein a light-emitting element that needs to emit light to a far distance emits light to have a relatively narrow radiation angle.

7. The light-emitting unit of claim 1, wherein a light-emitting element that needs to emit light to a near distance emits light to have a relatively wide radiation angle.

8. A TOF sensor comprising:
a light-emitting array comprising a light-emitting unit;
a light-receiving unit configured to receive reflected light reflected from an object; and
an operation processing unit configured to calculate, from a transmission time of light from the light-emitting unit and a reception time of reflected light sensed by the light-receiving unit, a light flight time corresponding to a time difference between the transmission time of the light and the reception time of the light, and to calculate a distance to the object from the calculated light flight time,
wherein the light-emitting unit comprises:
a base substrate;
a plurality of groups of light-emitting elements arranged on the base substrate and sequentially arranged in a preset shape at the outermost position and inside the outermost position; and
address lines electrically connected to the light-emitting elements of each group, respectively, and electrically disconnected from each other, and
wherein some or all of the light-emitting elements have different radiation angles.

9. The TOF sensor of claim 8, wherein the further comprising:
a plurality of groups of optical lenses disposed on the light-emitting elements of each group.

10. The TOF sensor of claim 9, wherein some or all of the optical lenses have different curvatures or refractive powers.
